(19) United States
(12) Patent Application Publication
(10) Pub. No.: US 2003/0081881 A1
(43) Pub. Date: May 1, 2003

(54) Methods and apparatus for analyzing waveguide couplers

(76) Inventors: Carlos Alegria, Hampshire (GB); Mikhail Nickolaos Zervas, Hampshire (GB)

Correspondence Address: Finnegan, Henderson, Farabow,, Garrett & Dunner, L.L.P., 1300 I Street, N.W., Washington, DC, 20005-3315, US

(21) Appl. No.: 10/216,890

(22) Filed: Aug. 13, 2002

Related U.S. Application Data
(60) Provisional application No. 60/313,522, filed on Aug. 21, 2001.

(30) Foreign Application Priority Data
Aug. 14, 2001 (EP) 01306893.7

(51) Int. Cl. G02B 6/26

(52) U.S. Cl. 385/15; 385/39

(57) ABSTRACT

Methods for analyzing waveguide couplers are non-destructive, and comprise introducing probe light into a coupler; providing a source of perturbing radiation; presenting the coupling region of the coupler to the perturbing radiation to generate a temperature gradient across the waveguide, either from a direction so as to expose one waveguide before another waveguide and perturb the coupling region asymmetrically, or from a direction so as to expose the waveguides together and perturb the coupling region symmetrically; monitoring the power and/or phase of transmitted probe light, and repeating the presenting and monitoring along the length of the coupling region. Theoretical modeling shows that the transmitted probe light contains information from which can be derived the coupling profile, and power evolution and distribution along the coupling region, including location of the 50-50% points.

### BACKGROUND OF THE INVENTION

The invention relates to methods for analyzing waveguide couplers, especially but not exclusively optical fiber waveguide couplers, and also to apparatus suitable for carrying out the methods.

Optical waveguide couplers, such as fiber-optic couplers and integrated optic couplers, are widely used in many photonics applications. A common coupler configuration is a four-port device having two input ports and two output ports, with two waveguides in close proximity at a waist, forming a coupling region. Operation relies on distributed coupling between the individual waveguides, which in turn results in a gradual power transfer between optical modes supported by the individual waveguides. Alternatively, the power transfer and cross-coupling at the output ports can be viewed as a result of beating between the eigenmodes of the waveguide structure along the length of the coupling region.

Couplers can be used as power splitters to split the optical power of an optical channel having a particular wavelength. They can also be used to combine or split the power of different channels, corresponding to different wavelengths. Such couplers are wavelength-division-multiplexing (WDM) splitters or combiners. A recent development is the optical add/drop multiplexer (OADM), in which a coupler has a reflective Bragg grating written into the coupler waist, which provides selective adding and dropping of different channels having different wavelengths.

The performance of couplers and coupler-based devices depends on the coupling constants of the coupler, and on the power distribution along the coupling region. The response of OADMs, for example, is critically dependent on the exact positioning of the grating. The grating needs to be accurately positioned at the point along the coupler waist at which the power components in the individual waveguides are equal to each other. Therefore, it is necessary to be able to accurately locate these points so that the gratings can be written in the correct position. With regard to other coupler devices, such as power splitters or WDM couplers, coupler characterization allows for the identification of manufacturing errors and the optimization of fabrication procedures.

Methods capable of analyzing mode evolution parameters in the coupling region of a coupler would therefore be useful. Useful parameters include power evolution, i.e. power in each component waveguide as a function of position along the coupling region, and coupling constant along the length of the coupling region.

A previously proposed characterization method measures the coupling length of a coupling region in planar waveguide couplers [1]. In this method, a small differential loss is induced in one of the waveguides, which perturbs the coupler output in a manner which relates to the position of the induced loss. The loss is induced by sliding a drop of mercury along one of the waveguides in the coupling region. The mercury drop has the effect of absorbing a fraction of the light propagating through the waveguide. To prevent loss in the other waveguide, the other waveguide is masked, i.e. covered, with a resist film.

Another previously proposed method for characterizing planar waveguide couplers measures the coupler beat period [2]. A 1 μm-thick layer of black ink is spin-coated onto the surface of the planar waveguide structure. The coupling region is then perturbed by directing a light beam of 980 nm radiation from a semiconductor laser diode onto the ink, directly above the location of one of the waveguides. The ink strongly absorbs the 980 nm radiation, and reradiates heat to cause local heating of the waveguide situated directly below the ink.

While of use for characterizing planar waveguide couplers, neither method is suitable for characterizing fused taper optical fiber couplers. This follows from a fundamental limitation of both methods which is the requirement to selectively perturb only one of the two waveguides in the coupling region. In planar waveguides, there is a distinct geometric separation of the waveguides, whereas this is not generally the case for a fused taper optical fiber coupler produced by melting, and sometimes also twisting. Moreover, the circular cross-sectional shape and smaller cross-sectional dimensions of fiber couplers presents further experimental problems.

Another issue is that both the prior art methods involve undesirable processing of the couplers, namely, the application of resist film or absorptive ink. The characterization methods are essentially non-destructive, but these additional processing steps increases the risk of coupler damage. Also, while these kinds of processing may be acceptable for planar waveguides, which are relatively robust, they are less suitable for fiber couplers. Fiber couplers are more fragile and prone to failure and damage in processing. Furthermore, fiber couplers generally provide no flat surface for coating which makes it difficult to apply coatings or masking layers.

An improved coupler analysis method and apparatus is therefore desired that can be applied to optical fiber couplers as well as planar waveguide couplers.

### SUMMARY OF THE INVENTION

A first aspect of the present invention is directed to a method of analyzing a waveguide coupler having a coupling region with axial length and comprising first and second waveguides extending side-by-side, the method comprising:

introducing probe light into the coupler;

providing a source of perturbing radiation;

presenting the coupling region to the perturbing radiation from a direction that exposes the first waveguide prior to the second waveguide so as to generate a temperature gradient across the coupling region, thereby to perturb the coupling region asymmetrically;

monitoring the probe light transmitted by the coupler; and

repeating the presenting and monitoring steps for a sequence of axial length portions of the coupling region.

A second aspect of the present invention is directed to a method of analyzing a waveguide coupler having a coupling region with axial length and comprising first and second waveguides extending side-by-side, the method comprising:

introducing probe light into the coupler;

providing a source of perturbing radiation;

presenting the coupling region to the perturbing radiation from a direction that exposes the first waveguide and the second waveguide together so as to generate a temperature gradient across the coupling region, thereby to perturb the coupling region symmetrically;

monitoring the probe light transmitted by the coupler; and

repeating the presenting and monitoring steps for a sequence of axial length portions of the coupling region.

Theoretical analysis and modeling have shown that waveguide couplers may be analyzed and studied by applying perturbations, in this case in the form of temperature gradients, which extend across the whole of the coupling region. The temperature gradient may be oriented in any direction across the waveguide, and the information obtainable depends on the direction. This is a complete departure from the prior art methods, which have assumed that it is necessary to localize the perturbation to only one waveguide out of a pair of waveguides. In fact, application of a perturbation across the whole of the coupling region yields information from which can be derived a greater variety of waveguide characteristics than can be obtained by methods which use a localized perturbation. The theory indicates that symmetric and asymmetric perturbations give information relating to different characteristics of a waveguide, so that the methods can be used selectively or in conjunction to obtain desired results.

Moreover, the perturbations can be applied non-destructively by a temperature gradient across temperatures well below the damage threshold for the material under study, such as silica glass.

The term “waveguide” is to be understood as encompassing coupler geometries beyond those in which individual waveguides are separate and well-defined within the coupling region. For example, in an optical fiber coupler in which the coupling region is formed by fusing fibers together, the waveguides may_be distinct. Therefore, “waveguide” applies to all coupler configurations, and should be interpreted in terms of the field intensities of light propagating within the coupler in the absence of physically well-defined waveguides.

In an embodiment of the first aspect of the invention, the perturbation is achieved by directing the perturbing radiation onto the coupler in a direction substantially parallel to a plane containing the waveguides within the coupler and perpendicular to the axial length of the coupling region. This is a convenient arrangement for asymmetric perturbation of a fiber coupler, in which the waveguides are closely spaced.

In an embodiment of the second aspect of the invention, the perturbation according to the second aspect is achieved by directing the perturbing radiation onto the coupler in a direction substantially perpendicular to both a plane containing the waveguides within the coupler and to the axial length of the coupling region.

The methods permit non-destructive testing of a waveguide coupler without any requirement for additional treatment of the coupler before analysis. As there is no requirement for the perturbation to be localized in only one waveguide, the need for protective or absorbent coatings or layers to be applied to the surface of the coupler is avoided. This is especially advantageous in the case of fused taper optical couplers fabricated from optical fibers. The small waist diameters of these couplers makes them fragile and hence prone to failure during post-fabrication treatments such as the application of coatings. However, regardless of the coupler construction, the lack of necessity for such coatings is beneficial in terms of simplification of procedures, reduced cost and reduced risk of damage.

In an embodiment of the first aspect, the transmitted probe light has a power which is monitored during the monitoring step. The transmitted power can be shown to relate to the distribution of the radiation between the waveguides at the axial position at which the perturbation is generated, so that power measurements can yield particular information concerning the operation of the coupler. For example, the monitoring of the power of the transmitted probe light may include noting at which axial length portion or portions the power has a maximum and/or a minimum value. In a coupler having two waveguides, the power maximizes when the perturbation is generated at a position at which there is an equal amount of transmitted radiation in each waveguide (50-50% point), and minimizes at a position at which all transmitted radiation is contained within one waveguide (0-100% point).

The method may further comprise applying a correction to an axial position of the noted axial length portion or portions in the event that the coupler is a single or multiple full-cycle coupler and the analysis is carried out under conditions in which the coupler is detuned from ideal operation. The new theory developed below shows that the observed power maxima shift from the 50-50% points when a coupler is detuned, but the corrections required to locate the 50-50% points can be readily calculated from formulae.

The detuning may arise from distortion of the axial length of the coupling region, for example because the coupler is stretched during the analyzing process, or because of manufacturing errors. The detuning may also arise from the probe light having a wavelength which differs from a wavelength at which ideal operation of the coupler is defined. This wavelength is known as the resonance wavelength, and is the wavelength at which the coupler is designed to give optimum operation. Errors arising from either of these types of detuning can be corrected for. In the latter case, the availability of correction formulae means that it is not essential to use a particular probe light wavelength to analyze a particular coupler.

In a further embodiment of the first aspect, the transmitted probe light has a phase which is monitored during the monitoring step. According to the theory, the phase is proportional to the radiation power within a waveguide at the perturbation position. Therefore, a record of the phase variation as a function of the axial position of the perturbation effectively maps the evolution of the power along the waveguide.

In an embodiment of the second aspect, the transmitted probe light has a power which is monitored during the monitoring step. The theory developed below indicates that the variation of the power with the position of the perturbation along the axial length of the coupling region follows the coupling profile.

In either of the first or second aspects, the perturbing radiation may comprise electromagnetic radiation. For example, the source may be a laser. The perturbing radiation is typically absorbed directly by the material of the coupling region so that the material is heated and the temperature gradient is generated, although it is possible to apply a thermally absorbing layer which is heated by the perturbing radiation and reradiates heat to the coupling region. The highly stable outputs which are available from lasers give even and consistent heating. Hence the results of the analysis are not affected by fluctuations in the heating process. Additionally, the wide range of lasers available means that it is typically straightforward to provide a laser that will generate perturbing radiation of a wavelength that is suitably absorbed, whatever the material of the coupler.

Advantageously, the electromagnetic radiation has a wavelength selected to have an absorption length in the coupling region of between 0.1 and 7 times a distance equal to half of the coupling region width. This avoids the requirement for any kind of thermally absorbing layer to be applied to the coupler surface to absorb the perturbation radiation and transfer the heating effect to the coupler material. Additionally, the theory shows that this range of absorption lengths gives an adequate amount of coupling, while offering flexibility in the choice of the source of perturbing radiation.

If the waveguide coupler is an optical fiber waveguide coupler with a coupling region of generally circular cross-section, then its radius comprises the distance equal to half of the coupling region width.

In one embodiment, the coupling region is made from a material comprising silica, and the source is a carbon dioxide laser. The perturbing radiation will therefore have a wavelength of approximately 10 ,μm. Silica is widely used as a waveguide material so that the analysis of silica couplers is a common requirement. Radiation with a wavelength of 10 μm has an absorption length in silica of the order of 5 μm. A silica fiber coupler may typically have a waist radius of the order of 16 μm, so that the 10 μm perturbing radiation will provide a temperature gradient giving a high level of coupling.

In an alternative embodiment, the perturbing radiation may comprise heat radiation, which may be provided by a source which is a resistively heated element. Thus, the perturbation can be generated in circumstances in which a suitable electromagnetic source is not available.

A third aspect of the present invention is directed to a method of analyzing a waveguide coupler having a coupling region with axial length and comprising first and second waveguides extending side-by-side, the method comprising:

introducing probe light into the coupler;

providing a source of perturbing radiation;

selecting a first direction from which to present the coupling region to the perturbing radiation;

presenting the coupling region to the perturbing radiation;

monitoring the probe light transmitted by the coupler;

repeating the presenting and monitoring steps for a sequence of axial length portions of the coupling region;

selecting a second direction from which to present the coupling region to the perturbing radiation; and

repeating the presenting and monitoring steps for a sequence of axial length portions of the coupling region;

wherein presenting the coupling region from one of the first direction and the second direction exposes the first waveguide prior to the second waveguide so as to generate a temperature gradient across the coupling region, thereby to perturb the coupling region asymmetrically, and presenting the coupling region from the other of the first direction and the second direction exposes the first and second waveguides together so as to generate a temperature gradient across the coupling region, thereby to perturb the coupling region symmetrically.

By this method, the characteristics of a coupler which can be derived from analyses performed under asymmetric and symmetric perturbation can be determined quickly and in a non-destructive fashion in one procedure. The two perturbations can be achieved by, for example, rotating the coupler by 90° about its longitudinal axis after the first repeating step, or by redirecting the perturbing radiation after the first repeating step so that it is incident on a different side of the coupler.

A fourth aspect of the present invention is directed to a method of analyzing a waveguide coupler having a coupling region with axial length and comprising first and second waveguides extending side-by-side, the method comprising:

introducing probe light into the coupler;

providing a source of perturbing radiation;

setting the perturbing radiation to a first power;

presenting the coupling region to the perturbing radiation from a direction that exposes the first waveguide prior to the second waveguide so as to generate a temperature gradient across the coupling region, thereby to perturb the coupling region asymmnetrically;

monitoring the probe light transmitted by the coupler;

repeating the presenting and monitoring steps for a sequence of axial length portions of the coupling region;

setting the perturbing radiation to a second power; and

repeating the presenting and monitoring steps for a sequence of axial length portions of the coupling region.

This method allows complete analysis of a coupler using asymmetric perturbation only. The theory indicates that a low level of asymmetric perturbation gives a similar effect to a high level of symmetric perturbation. The level of perturbation may be modified by varying the power of the perturbing radiation. The method may be useful in circumstances where it is more convenient to modify the perturbation radiation power level than to rotate the coupler (for example, if the coupler is very fragile).

A fifth aspect of the present invention is directed to apparatus for analyzing a waveguide coupler, comprising:

a source of probe light operable to emit probe light for introducing into a waveguide coupler;

a mount for holding a waveguide coupler;

a source of perturbing radiation operable to direct light radiation having a component of at least 2 μm in wavelength onto a waveguide coupler held in the mount with a direction of incidence;

a scanning arrangement operable to present a sequence of axial length portions of the coupling region of a waveguide coupler held in the mount to the perturbing radiation; and

a detector operable to monitor probe light transmitted by a waveguide coupler held in the mount.

The mount and/or the light source are preferably configured to allow a waveguide coupler held in the mount to be rotated relative to the direction of incidence of the perturbing radiation, thereby to switch between symmetric and asymmetric perturbation geometries.

The source of perturbing radiation may have a component of at least 3, 4, 5, 6, 7, 8, 9 or 10 μm in wavelength. Generally, the wavelength of the perturbing radiation will be chosen having regard to the absorption properties of the material making up the waveguide coupler. As discussed elsewhere in this document, the perturbing radiation is preferably selected to have an absorption length in the material of the coupling region that is comparable to, e.g. within one order of magnitude of, the cross-sectional dimensions of the coupler waist.

### BRIEF DESCRIPTION OF THE DRAWINGS

For a better understanding of the invention and to show how the same may be carried into effect reference is now made by way of example to the accompanying drawings in which:

FIG. 1 shows a schematic diagram of an apparatus according to an embodiment of the present invention;

FIG. 2 shows a schematic diagram of a four-port optical waveguide coupler;

FIG. 3(a) shows a schematic diagram of the coupler of FIG. 2 with an induced perturbation;

FIG. 3(b) shows schematic illustrations of four aspects of the induced perturbation of FIG. 3(a);

FIG. 4 is a schematic depiction of even/odd eigenmode beating and total power evolution along an unperturbed full-cycle waveguide coupler;

FIG. 5 is a schematic representation of scattering processes and coupling mechanisms induced in a coupler by an external refractive index perturbation;

FIG. 6 shows plots of the calculated relative variation of coupling coefficients kᵢⱼ with absorption length 1/α of the perturbing radiation;

FIG. 7 shows plots of the calculated relative variation of coupling coefficients kᵢⱼ with coupler waist radii r;

FIG. 8 shows plots of the calculated variation of coupling coefficients kᵢⱼ with perturbing laser power P_{CO2}, for asymmetric perturbation;

FIG. 9 shows the results of a numerical simulation of the power perturbation P of an ideal uniform full cycle coupler under asymmetric perturbation as a function of position z along the coupler;

FIG. 10 shows the results of a numerical simulation of the power perturbation P of an uniform full cycle coupler with taper regions under asymmetric perturbation as a function of position z along the coupler;

FIG. 11 shows the results of a numerical simulation of the power perturbation P of an uniformly tapered full cycle coupler with a small taper ratio under asymmetric perturbation as a function of position z along the coupler;

FIG. 12 shows the results of a numerical simulation of the power perturbation P of an uniformly tapered full cycle coupler with an extreme taper ratio under asymmetric perturbation as a function of position z along the coupler;

FIG. 13 shows the results of a numerical simulation of the power perturbation P of a non-uniform coupler under asymmetric perturbation as a function of position z along the coupler;

FIG. 14 shows the results of a numerical simulation of the power perturbation P of full cycle couplers under various amounts of phase detuning caused by different coupler lengths under asymmetric perturbation as a function of position z along the coupler;

FIGS. 15(a)-(c) show the results of a numerical simulation of the power perturbation P of full cycle couplers under asymmetric perturbation as a function of position z along the coupler, for a phase matched condition, FIG. 15(a), and positive and negative phase detuning, FIGS. 15(b) and (c), the phase change being caused by use of different probe light wavelengths;

FIG. 16 shows the results of a numerical simulation of the power perturbation P of half-cycle couplers as a function of position z along the coupler, for a phase matched condition, FIG. 16(a), and positive and negative phase detuning, FIGS. 16(b) and (c), the phase change being caused by use of different probe light wavelengths;

FIG. 17 shows the results of a numerical simulation of the phase perturbation θ of a full cycle coupler under asymmetric perturbation as a function of position z along the coupler;

FIG. 18 shows the experimental results of analysis of a half-cycle coupler under symmetric and asymmetric perturbation, as plots of power perturbation P against position z along the coupler;

FIG. 19 shows the experimental results of analyzing a half-cycle coupler under asymmetric perturbation using different probe light wavelengths, as plots of power perturbation P against position z along the coupler; the graph inset shows the measured spectral response (power P against wavelength λ) of the coupler for the different probe light wavelengths;

FIG. 20 shows the experimental results of analyzing a full cycle coupler under symmetric and asymmetric perturbation, as plots of power perturbation P against position z along the coupler;

FIG. 21 shows the experimental results of analyzing a full cycle coupler under asymmetric perturbation using different powers of perturbing radiation, as plots of power perturbation P against position z along the coupler; and

FIG. 22 shows the experimental results of analyzing a complex non-uniform coupler under asymmetric and symmetric perturbation, as plots of power perturbation P against position z along the coupler.

### DETAILED DESCRIPTION

Apparatus and Method

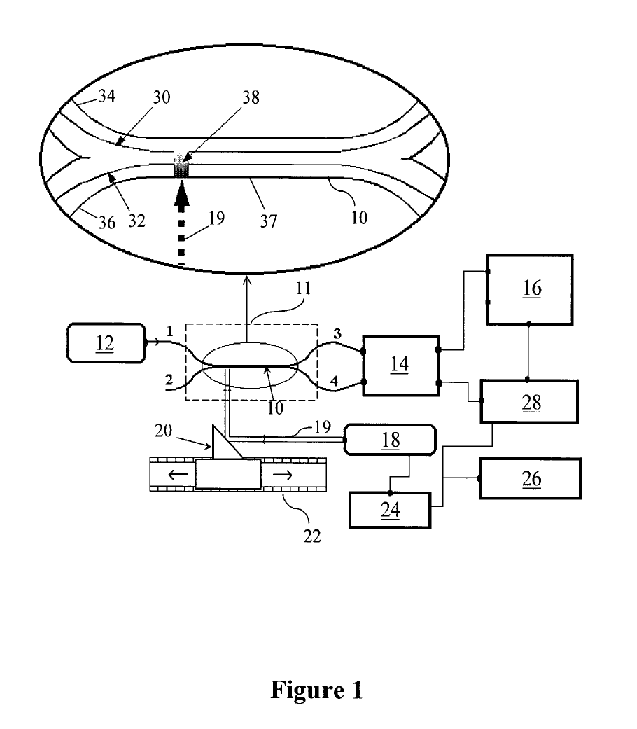

FIG. 1 is a schematic diagram of an embodiment of an apparatus for analyzing a waveguide coupler.

A waveguide coupler 10 has the form of a four-port optical fiber coupler comprising two silica optical fibers fused to create a coupling region (defined in the Figure by the oval outline). The four ports of the coupler 10 are labeled 1, 2, 3 and 4. The coupler 10 is arranged on a mount 11 to hold it in a defined position and alignment.

A laser diode 12 is provided to generate probe light having a wavelength of 1.55 μm. The probe light is launched into port 1 of the coupler 10. A detector 14 is arranged to detect the probe light which exits from ports 3 and 4 after being transmitted by the coupler 10. The detector 14 may detect the power or the phase of the probe light. Any conventional detectors and detection techniques are suitable. Specifically, lock-in techniques may be used for noise reduction. A data acquisition card 16 is arranged to receive signals from the detector 14, for data storage and signal processing.

A second laser 18 is provided to generate a beam of perturbing radiation 19. The laser 18 is a carbon dioxide (CO₂) laser to provide perturbing radiation at a wavelength of 10.6 ,μm. An angled mirror 20 is mounted on a translation stage 22. The mirror 20 directs the beam 19 of perturbing radiation onto the coupling region of the coupler 10 so that it exposes the coupler in a line or stripe extending across the coupling region. The position of the mirror 20 can be scanned by the translation stage 22 in a direction parallel to the length of the coupling region, so that the beam of perturbing radiation 19 can be scanned along the length of the coupling region.

Operation of the CO₂ laser is modulated by a controller 24 in response to a signal from a signal generator 26. The signal is also sent to a lock-in amplifier 28 which is in communication with the detector 14 and the acquisition card 16. In this way, the transmitted probe light can be detected and amplified in phase with the perturbing radiation, to improve the signal-to-noise ratio.

The enlarged section of FIG. 1 shows the coupling region 37 of the coupler 10 in more detail. The two fibers 34, 36 of the coupler 10 each have a core 30, 32. The cores 30, 32 are brought into close proximity in the coupling region 37 where the fibers 34, 36 are fused. The beam of perturbing radiation 19 is incident on the side of the coupling region 37, and induces a perturbation 38 in a localized volume of the coupling region 37.

The analysis method is carried out by first launching probe light continuously into the coupler 10. The beam of perturbing radiation 19 is then directed onto the coupling region 37 at a particular location. The perturbing radiation is absorbed by the material forming the coupling region and heats the material so that a temperature gradient is established across the coupling region. This is represented in FIG. 1 by the shading of the perturbation 38. Denser shading schematically indicates a higher temperature. The heating causes a localized change in the refractive index of the material, so that a refractive index gradient is induced through the coupling region. This has the effect of changing the way in which the probe light propagates along the coupling region, and hence how much probe light exits the two ports 3 and 4. The probe light is detected by the detector 14. The response of the detector is stored on the acquisition card 16 as a function of the position along the coupling region 37 at which the perturbation was induced. The signal-to-noise ratio of the detector response is improved by the use of the signal generator 26 and the lock-in amplifier 28 because the modulation of the perturbing radiation modulates the refractive index change which in turn modulates the probe light.

The beam of perturbing radiation 19 is then scanned to a new position along the coupling region 37 by using the translation stage 22 to move the mirror 20, and the probe light is again recorded by the detector as a function of perturbation position. This process is repeated until as much of the coupling region 37 as is of interest has been subjected to the perturbing radiation.

A theoretical study and modeling of the perturbation process shows that the probe light is affected by the perturbation in such a way as to yield information relating to the distribution of transmitted power between the waveguides 34, 36 of the coupler 10, the evolution of transmitted power along the coupling region 37 and the profile of the coupling coefficient along the coupling region 37. Thus the characteristics of the coupler 10 can be readily ascertained from a non-destructive analysis. The theory is presented in full later, followed by experimental results.

In FIG. 1, the perturbing radiation is shown as being directed onto the side of the coupling region, that is, in a direction which is substantially parallel to the plane in which the waveguides 34, 36 are located and perpendicular to the optical axis of the coupling region. This arrangement means that the waveguide 36 is exposed to the perturbing radiation prior to the waveguide 34 so that the waveguides experience different amounts of heating and hence different levels of perturbation. This is an “asymmetric” perturbation viewed geometrically, and, more fundamentally, is also asymmetric with respect to the symmetry of eigenmode power distribution through the coupling region.

Alternatively, the perturbing radiation can be directed onto the coupling region in a direction which is substantially perpendicular to the plane of the waveguides and perpendicular to the optical axis. This configuration exposes both waveguides to the perturbing radiation together so that the waveguides experience the same amount of heating and the same level of perturbation. This is a “symmetric” perturbation, and is also symmetric with respect to the symmetry of eigenmode power distribution through the coupling region. Symmetric perturbation produces no result if used on a coupling region which is uniform along its length, but does yield information for non-uniform couplers such as a fiber coupler which has a tapered region at each end of the coupling region. A non-uniform coupler is one which has variation in coupling constant along the coupling region. This variation may arise, for example, from non-uniformities in the coupling region width or waveguide spacing, and may be intentional or due to manufacturing errors.

Asymmetric and symmetric perturbation are able to yield information relating to different characteristics of the coupler. Therefore, a considerable amount of information can be obtained if the method includes first detecting probe light as a function of perturbation position for asymmetric (or symmetric) perturbation, and then repeating this for symmetric (or asymmetric) perturbation. This can be simply achieved by rotating the coupler by 90° between sets of measurements. Alternatively, a mirror arrangement may be used to direct the perturbing radiation onto a different part of the coupling region. An asymmetric perturbation permits the mapping of the power evolution along the length of the coupling region, and in particular, allows location of the position or positions at which the power is equally split between the waveguides (50-50% point). A symmetric perturbation allows the mapping of the coupling profile or coupling constant along the length of the coupling region.

Additionally, it can be shown that, under asymmetric perturbation, different levels of perturbation have different effects, giving different information. The level of perturbation depends on the size of the induced change in refractive index. The perturbation level can be modified by alteration of the power of the incident perturbing radiation, which changes the amount of heating. A low level of asymmetric perturbation has a similar effect on the transmitted probe light as a higher level of symmetric perturbation. Therefore, a waveguide coupler may be analyzed by inducing an asymmetric perturbation with perturbing radiation at a first power level and detecting the power of the transmitted probe light, followed by inducing an asymmetric perturbation with perturbing radiation at a second power level and detecting the power of the transmitted probe light. This has the experimental advantage of avoiding having to alter the direction of incidence of the perturbing radiation during scanning in order to obtain the information usually obtained with higher intensity symmetric perturbation. The disadvantage is that the low intensity perturbation needed to yield this information may give rise to signal-to-noise problems.

Lasers are suitable as a source of probe light. The theory shows that the accuracy of some results of an analysis can be improved by using probe light of a wavelength equal or close to the resonant wavelength of the coupler. The resonant wavelength is the wavelength of light for which the coupler is designed to operate most efficiently. However, the theory also shows that it is possible to apply corrections to results in the event that the probe light differs from the resonant wavelength. Therefore, the use of probe light which matches the resonant wavelength is not essential. A tunable laser may be used to provide the probe light, so that the apparatus can be readily modified for the analysis of many couplers.

Alternative arrangements may be used to induce the temperature gradient, in place of the CO₂ laser. All that is required is a source of perturbing radiation which will produce localized heating in the coupling region. Therefore, other lasers or sources of electromagnetic radiation are suitable. Alternatively, heat radiation can be used as the perturbing radiation. To provide this, an electrical heating wire may be scanned across the coupler, the temperature of the wire being controlled by adjustment of electric current applied to it. However, this technique tends to be more difficult to control than using a laser, owing to oscillations in the electric current as well as heat convection losses which can influence the temperature of the wire and the surrounding air and hence affect the induced perturbation. Therefore, use of a laser or other directional light source to induce the heating is preferred. In general, the heat source should only cause a small non-permanent perturbation to the coupler so that the analysis is non-destructive and so that coupler performance is not changed during analysis by thermally induced refractive index changes.

The apparatus described above features a CO₂ laser as a source of 10.6 μm perturbing radiation used to analyze a silica coupler. Radiation at a wavelength of 10.6 μm has an absorption length in silica of approximately 1 to 6 μm. A typical fiber coupler waist radius may be 16 μm. According to the theory, the effect of the induced perturbation on the probe light is optimized for absorption lengths that are comparable to the coupling region radius, so that a CO₂ laser is a good choice for the analysis of silica couplers. Other wavelengths of perturbing radiation can be selected as appropriate depending on the absorption properties of the material of the coupler. The absorption length, 1/α (where α is the linear absorption coefficient of a material at a particular wavelength) is defined as the length of absorbing material in which the power of incident radiation is reduced to 1/e of its original value. The use of a wavelength which is substantially absorbed within a length comparable to the coupler size means that there is no requirement for a thermal absorbing layer as has been proposed in the prior art [2].

The methods are applicable to many types of waveguide coupler. They are especially suitable for the analysis of fused fiber couplers, as the small waist size of these couplers makes them prone to damage by any method which requires the application of masking or absorbing layers to the coupling region surface. Additionally, the methods apply a perturbation across the whole width of the coupling region, so there is no requirement to isolate the effect in just one waveguide. This is impractical in a fused fiber coupler, in which the boundary between waveguides is indistinct. However, the method may also be applied to planar waveguides, including those with a buried core. Selection of a perturbing wavelength which is absorbed at an appropriate depth in the coupling region material allows the temperature gradient to be induced at the correct location, in accordance with the perturbation required.

In the case of a fiber coupler in which the coupling region is formed by twisting the individual fibers before fusing them (such as a null coupler), the method should preferably be modified so that the scanning of the perturbing radiation follows the twist along the coupling region. This may be achieved by rotating the coupler during the scan. This is necessary to ensure that either a symmetric or asymmetric perturbation is maintained throughout the scan. If the scan does not follow the twist, the perturbation will alter between symmetric and asymmetric during the course of the scan. This will give convolved data, rendering subsequent interpretation of the analysis more complicated.

Theoretical Analysis of the Method

Optical waveguide couplers are generally formed by bringing two or more waveguides (e.g. planar, ridge, or diffused waveguides, or optical fibers) into close proximity so that optical power can be exchanged between them through evanescent field interaction.

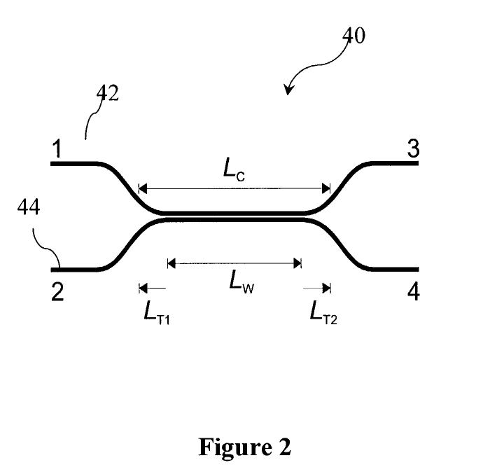

FIG. 2 shows a schematic diagram of a generic four-port (2×2) coupler 40. The ports are labeled 1, 2, 3 and 4, with 1 & 2 being input ports and 3 & 4 being output ports. The coupler 40 comprises two waveguides 42, 44 which, in use, exchange powers over a coupling region L_{C}, which comprises a coupler waist L_{W} and two taper regions L_{T1}, L_{T2}, one on each side of the coupler waist. The taper regions are adiabatic in order to avoid higher-order and radiation mode excitation that can contribute to losses. The coupling process along the taper regions, which can be described by a varying coupling constant, is non-uniform and accounts for a substantial part of the total exchanged power. The taper regions should, therefore, be taken into account when considering practical coupled devices. The waist region, on the other hand, is generally assumed to be uniform and is described by a fixed coupling constant. However, in practice, the waist can show sizeable non-uniformities that may need to be accounted for in order to accurately describe the device performance. The degree of non-uniformity tends to depend on the fabrication process used to make the coupler.

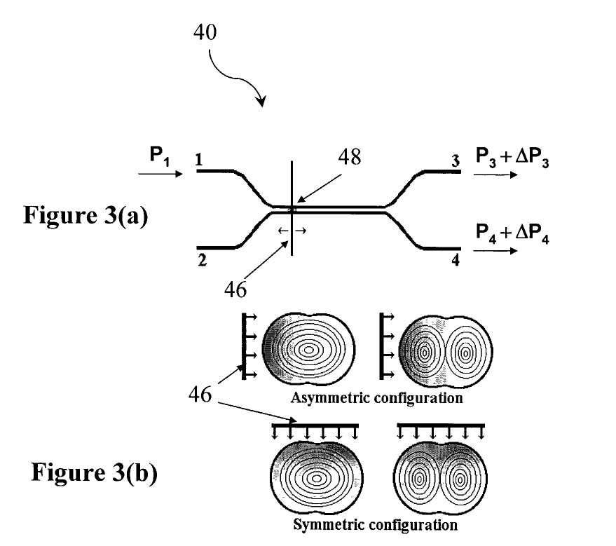

FIGS. 3(a) and 3(b) show schematic diagrams of a coupler with an induced perturbation, and of the nature of the perturbation. These illustrate the principle of operation of the methods of the present invention. FIG. 3(a) shows a coupler 40 of the type shown in FIG. 2. Light of a suitable wavelength, having power or phase P₁, is launched into input port 1 (although input port 2 may be used). A perturbing element 46 (such as the CO₂ laser in FIG. 1) induces a local perturbation 48 in the coupling region of the coupler 40. The change in power or phase ΔP caused by the perturbation 48 is monitored at one or both of the output ports (3 and 4). The power or phase exiting the output ports can be designated P₃+ΔP₃ and P₄+ΔP₄. The local perturbation 48 is induced non-destructively by a temperature gradient across the coupling region.

FIG. 3(b) shows the effect of the perturbation 48 induced by the perturbing element 46 in more detail. The Figure shows the coupling region in cross-section, supporting either an even eigenmode (left hand cross-sections) or an odd eigenmode (right hand cross-sections). The perturbation 48 can be asymmetric (upper cross-sections) or synmnetric (lower cross-sections) with respect to the power distribution of the even and odd eigenmodes, i.e. with respect to the power distribution across the coupling region. As indicated above, the different applied perturbations can provide information about different coupler parameters.

The symmetric and asymmetric perturbation methods described above are based on development of a new theoretical analysis which is now described. The theoretical analysis is based on coupled mode theory.

Consider the 2×2 coupler shown schematically in FIG. 2, having four ports 1, 2, 3 and 4. Input port 1 and output port 3 are at either end of waveguide 1 and input port 2 and output port 4 are at either end of waveguide 2. When probe light is launched into port 1, the normalized field amplitudes of the even (Aₑ) and odd (Aₒ) eigenmodes at the coupler input (z=0) can be approximated by:

$${A}_{e} ( 0 ) = \frac{{A}_{1} ( 0 ) + {A}_{2} ( 0 )}{\sqrt{2}} ; \\ {A}_{o} ( 0 ) = \frac{{A}_{1} ( 0 ) - {A}_{2} ( 0 )}{\sqrt{2}} \qquad ( 1 )$$

where A₁(0) and A₂(0) are the normalized amplitudes of the fields launched initially at the two input ports 1 and 2, respectively. For single port excitation, as shown in FIG. 2, A₁(0)=1 and A₂(0)=0 and, through Equation (1), Aₑ(0)=Aₒ(0)=1/\sqrt{2}. Therefore, light launched into one of the input ports of a 2×2 coupler excites equally the two lowest-order (even and odd) eigenrodes along the coupling region. The two eigenmodes propagate adiabatically along the entire coupling region.

The propagating total electric field at any point along the coupler is given by:

$$\begin{matrix}{E}_{t} ( z ) = {E}_{e} ( z ) + {E}_{o} ( z ) \\ = {A}_{e} ( z ) {ⅇ}^{- ⅈ {\int }_{0}^{2} {β}_{e} ( ζ ) ⅆ ζ} + \\ {A}_{o} ( z ) {ⅇ}^{- ⅈ {\int }_{0}^{2} {β}_{o} ( ζ ) ⅆ ζ}\end{matrix} \qquad ( 2 )$$

During adiabatic propagation, the even and odd eigenmodes retain their amplitude (Aₑ(z)=Aₑ(0) and Aₒ(z)=Aₒ(0)) and only change their relative phase. This results in spatial beating along the coupler waist and power redistribution between the two individual waveguides comprising the optical coupler. The peak field amplitudes for each individual waveguide, along the coupling region, can be approximated by:

$${E}_{1} ( z ) = \frac{{E}_{e} ( z ) + {E}_{o} ( z )}{\sqrt{2}} = cos ( \frac{1}{2} φ ( z ) ) {ⅇ}^{- ⅈ \frac{1}{2} {\int }_{0}^{z} [ {β}_{e} ( ζ ) + {β}_{o} ( ζ ) ] ⅆ ζ} \\ {E}_{2} ( z ) = \frac{{E}_{e} ( z ) - {E}_{o} ( z )}{\sqrt{2}} = ⅈ sin ( \frac{1}{2} φ ( z ) ) {ⅇ}^{- ⅈ \frac{1}{2} {\int }_{0}^{z} [ {β}_{e} ( ζ ) + {β}_{o} ( ζ ) ] ⅆ ζ} \qquad ( 3 )$$

where

$$φ ( z ) = {φ}_{eo} ( z ) = {\int }_{0}^{z} Δ {β}_{eo} ( ζ ) ⅆ ζ = {\int }_{0}^{z} [ {β}_{e} ( ζ ) - {β}_{o} ( ζ ) ] ⅆ ζ$$

is the relative accumulated phase difference between the even and odd eigenmodes. βₑ and βₒ are the propagation constants of the even and odd eigenmodes, respectively. The corresponding normalized peak powers carried by the individual waveguides 1 and 2 are given by P₁₍₂₎=|E₁₍₂₎|², namely:

$${P}_{1} ( z ) = {cos}^{2} ( \frac{1}{2} φ ( z ) ) \\ {P}_{2} ( z ) = {sin}^{2} ( \frac{1}{2} φ ( z ) ) \qquad ( 4 )$$

At the points along the coupler where φ is zero or a multiple of 2π, the total power is concentrated predominantly around waveguide 1 (P₁=1 and P₂=0). At the points along the coupler where φ is a multiple of π the total power is concentrated predominantly around waveguide 2 (P₁=0 and P₂=1). Finally, at the points where φ is a multiple of π/2, the total power is equally split between the two waveguides (P₁=P2).

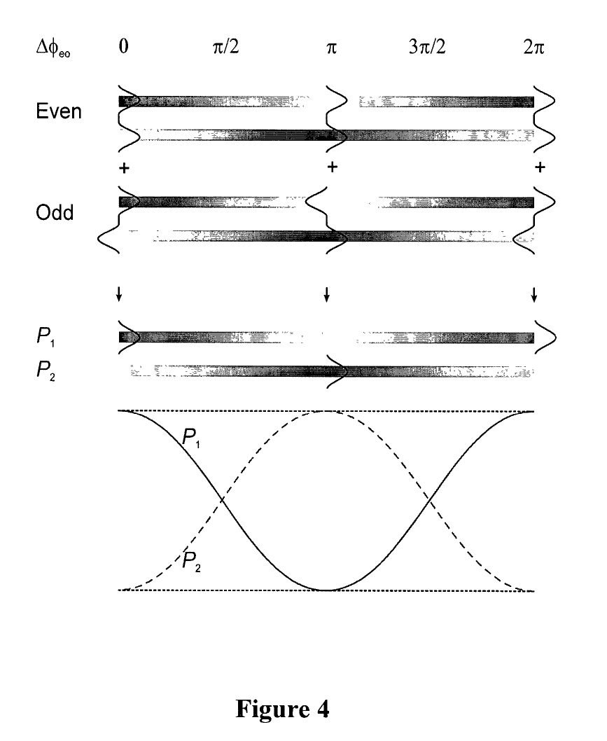

FIG. 4 shows, schematically, the even/odd eigenmode beating and total power evolution along an unperturbed single cycle full-cycle coupler (a coupler in which φ changes from 0 to 2π along the length of the coupling region). The changing value of φ is shown across the top of the Figure. In the central part of the Figure, the evolutions of the even eigenmode E and the odd eigenmode O are shown. The superposition of the eigenmodes determines the distribution of power between the waveguides 1 and 2, which support powers P₁ and P₂. This is shown at the bottom of the Figure, in the form of a graph. In the case of a non-uniform coupler waist, the non-uniformities are considered to be adiabatic so that no power exchange takes place between the two local eigenmodes and/or the radiation modes.

However, in the presence of a local non-adiabatic (symmetric or asymmetric) externally induced refractive index perturbation, at a given distance z₀ along the coupling region, the otherwise uncoupled even and odd eigenmodes scatter light into each other and perturb their amplitudes Aₑ, and Aₒ. The refractive index perturbation may be induced, for example, by establishing a thermal gradient across the coupling region. The interaction between the two propagating eigenmodes can be described by the following coupled-mode equations:

$$\frac{ⅆ {A}_{e}}{ⅆ z} = - ⅈ {k}_{ee} {A}_{e} - ⅈ {k}_{eo} {A}_{o} {ⅇ}^{ⅈ Δ β \cdot z} \\ \frac{ⅆ {A}_{o}}{ⅆ z} = - ⅈ {k}_{oo} {A}_{o} - ⅈ {k}_{oe} {A}_{e} {ⅇ}^{- ⅈ Δ β \cdot z} \qquad ( 5 )$$

where Δβ=βₑ-βₒ. The overall coupling process is characterized by four parameters, namely kₑₑ, kₒₒ, kₑₒ and kₒₑ. The parameters kₑₑ and kₒₒ are self-coupling coefficients, describing the scattering of each mode into itself, and result in a modification of the mode propagation constant locally. The parameters kₑₒ and kₒₑ, on the other hand, are cross-coupling coefficients, describing the scattering of each mode into the other, and give the interaction and power exchange between the even and odd modes.

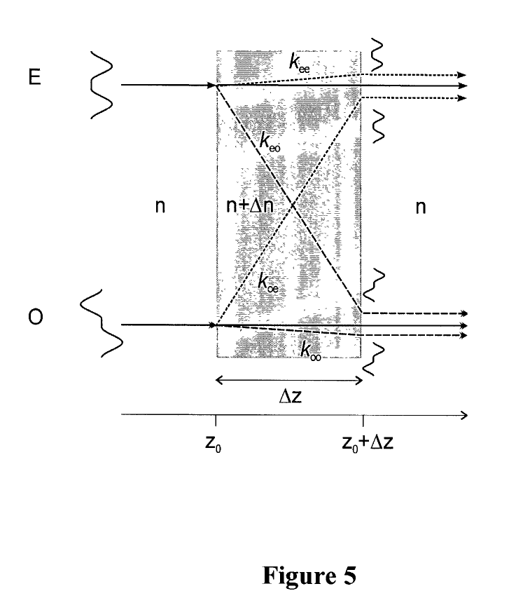

FIG. 5 shows a schematic representation of the scattering process and coupling mechanism induced by an external refractive index perturbation. The refractive index of the coupling region is defined as n, and the perturbation is defined as Δn, so that the refractive index in the volume in which the perturbation is induced (marked by the shaded area in the Figure) is n+Δn. The perturbation begins at a position z₀ and extends along the axial length of the coupling region for a distance Δz. The even eigenmode E and the odd eigenmode O are shown as receiving contributions arising from both the self-coupling coefficients kₑₑ and kₒₒ, and the cross-coupling coefficients kₑₒ and kₒₑ.

The coupling coefficients can be expressed as:

$${k}_{ee} ( z ) = \frac{ω}{4} \int Δ ϵ ( x , y , z ) {E}_{e}^{*} ( x , y ) {E}_{e} ( x , y ) ⅆ x ⅆ y \\ {k}_{oo} ( z ) = \frac{ω}{4} \int Δ ϵ ( x , y , z ) {E}_{o}^{*} ( x , y ) {E}_{o} ( x , y ) ⅆ x ⅆ y \\ {k}_{eo ( oe )} ( z ) = \frac{ω}{4} \int Δ ϵ ( x , y , z ) {E}_{e ( o )}^{*} ( x , y ) {E}_{o ( e )} ( x , y ) ⅆ x ⅆ y \qquad ( 6 )$$

where Δε=ε₀Δn²˜2ε₀nΔn is the dielectric permittivity perturbation. When the refractive index perturbation is uniform across the waist cross-section or symmetric with respect to the waist center, the cross-coupling coefficients are zero (kₑₒ=kₒₑ=0). When the refractive index perturbation is antisymmetric with respect to the waist center, the self-coupling coefficients are zero (kₑₑ=kₒₒ=0). In the general case of an asymmetric perturbation, all coupling coefficients are non-zero. Solving the coupled-mode equations (5) along the local perturbation length Δz gives the following expressions for the amplitudes of the perturbed even and odd mode fields:

$${A}_{e} ( {z}_{0} + Δ z ) = [ ( cos ( s Δ z ) - \frac{i σ}{s} sin ( s Δ z ) ) {A}_{e} ( {z}_{0} ) - \frac{{ik}_{eo}}{s} sin ( s Δ z ) {A}_{0} ( {z}_{0} ) ] {ⅇ}^{ⅈ \frac{Δ {β }^{′}}{2} Δ z} \\ {A}_{o} ( {z}_{0} + Δ z ) = [ - \frac{{ik}_{eo}}{s} sin ( s Δ z ) {A}_{e} ( {z}_{0} ) + ( cos ( s Δ z ) + \frac{i σ}{s} sin ( s Δ z ) ) {A}_{o} ( {z}_{0} ) ] {ⅇ}^{- ⅈ \frac{Δ {β }^{″}}{2} Δ z} \\ where \\ s = {( {k}_{eo}^{2} + {σ}^{2} )}^{1 / 2} , σ = \frac{Δ β}{2} + {k}_{diff} , {k}_{diff} = \frac{{k}_{ee} - {k}_{oo}}{2} , \\ \overline{k} = \frac{{k}_{ee} + {k}_{oo}}{2} \frac{Δ {β}^{′}}{2} = \frac{Δ β}{2} - \overline{k} , \frac{Δ {β}^{″}}{2} = \frac{Δ β}{2} + \overline{k} , Δ β = {β}_{e} - {β}_{o} \qquad ( 7 )$$

The propagation along an unperturbed coupler region, extending from z₁ to Z₂, can be described by:

$$\begin{matrix}[ \begin{matrix}{E}_{e} ( {z}_{2} ) \\ {E}_{o} ( {z}_{2} )\end{matrix} ] = [ \begin{matrix}{α}_{e} ( {z}_{1} , {z}_{2} ) & 0 \\ 0 & {α}_{o} ( {z}_{1} , {z}_{2} )\end{matrix} ] \cdot [ \begin{matrix}{E}_{e} ( {z}_{1} ) \\ {E}_{o} ( {z}_{1} )\end{matrix} ] \\ where & ( 8 ) \\ {α}_{e ( o )} ( {z}_{1} , {z}_{2} ) = {ⅇ}^{- ⅈ {\int }_{{z}_{1}}^{{z}_{2}} {β}_{e ( o )} ( z ) ⅆ z} & ( 9 )\end{matrix}$$

From Equation (7), on the other hand, the propagation along the perturbed region can be put in propagation matrix form as:

$$\begin{matrix}[ \begin{matrix}{E}_{e} ( {z}_{0} + Δ z ) \\ {E}_{o} ( {z}_{0} + Δ z )\end{matrix} ] = [ \begin{matrix}{T}_{11} & {T}_{12} \\ {T}_{21} & {T}_{22}\end{matrix} ] \cdot [ \begin{matrix}{E}_{e} ( {z}_{0} ) \\ {E}_{o} ( {z}_{0} )\end{matrix} ] \\ where & ( 10 ) \\ {T}_{11} = [ cos ( s Δ z ) - ⅈ \frac{σ}{s} sin ( s Δ z ) ] {ⅇ}^{- ⅈ \overline{β} Δ z} \\ {T}_{12} = {T}_{21} = - ⅈ \frac{{k}_{eo}}{s} sin ( s Δ z ) {ⅇ}^{- ⅈ \overline{β} Δ z} \\ {T}_{22} = [ cos ( s Δ z ) + ⅈ \frac{σ}{s} sin ( s Δ z ) ] {ⅇ}^{- ⅈ \overline{β} Δ z} & ( 11 )\end{matrix}$$

where

$$\overline{β} = \frac{{β}_{e} + {β}_{o}}{2} + \frac{{k}_{ee} + {k}_{oo}}{2}$$

is the average of the two perturbed propagation constants. The even and odd eigenmode fields at the coupler output (where z=L, L being the length of the coupler) are Eₑ(L,z₀) and Eₒ(L,z₀), respectively, with the perturbation applied at z=z₀. They are obtained in terms of the input fields Eₑ(0)=Aₑ(0) and Eₒ(0)=Aₒ(0) by multiplying the three pertinent propagation matrices and can be expressed as:

$$\begin{matrix}[ \begin{matrix}{E}_{e} ( L , {z}_{0} ) \\ {E}_{o} ( L , {z}_{0} )\end{matrix} ] = [ \begin{matrix}{α}_{e} ( {z}_{0} + Δ z , L ) & 0 \\ 0 & {α}_{o} ( {z}_{0} + Δ z , L )\end{matrix} ] \cdot \\ [ \begin{matrix}{T}_{11} & {T}_{12} \\ {T}_{21} & {T}_{22}\end{matrix} ] \cdot [ \begin{matrix}{α}_{e} ( 0 , {z}_{0} ) & 0 \\ 0 & {α}_{0} ( 0 , {z}_{0} )\end{matrix} ] \cdot \\ [ \begin{matrix}{A}_{e} ( 0 ) \\ {A}_{o} ( 0 )\end{matrix} ]\end{matrix} \qquad ( 12 )$$

The transfer matrix [T] of the perturbation can be further simplified by disentangling the coupling event from the propagation process over the perturbation length Δz. The perturbation transfer matrix is then approximately expressed as the product of a localized and instantaneous coupling matrix and a simple propagation matrix as follows:

$$[ \begin{matrix}{T}_{11} & {T}_{12} \\ {T}_{21} & {T}_{22}\end{matrix} ] = [ \begin{matrix}{C}_{11} & {C}_{12} \\ {C}_{21} & {C}_{22}\end{matrix} ] [ \begin{matrix}{ⅇ}^{- ⅈ ( {β}_{e} + {k}_{ee} ) Δ z} & 0 \\ 0 & {ⅇ}^{- ⅈ ( {β}_{o} + {k}_{oo} ) Δ z}\end{matrix} ] \qquad ( 13 )$$

where

C₁₁=C₂₂=cos(|kₑₒ|Δz) and C₁₂=C₂₁=−i sin(|kₑₒ|Δz)

The error involved in the approximation of Equation (13) is O(Δ³) and is negligible when the perturbation length Δz is very small. Substituting Equation (13) into Equation (12) the perturbed fields Eₑ(L,z₀) and Eₒ(L,z₀) of the even and odd modes, respectively, at the coupler output can be calculated with the perturbation at z₀. Using Equation (3) the fields of the outputs of the corresponding individual waveguides E₁(L,z₀) and E₂(L,z₀) can be calculated. After simple mathematic manipulations, the powers at the outputs of the corresponding individual waveguides P₁₍₂₎(L,z₀)=|E_{1(2)(L,z}₀)|² are expressed as:

$$\begin{matrix}\begin{matrix}{P}_{1} ( L , {z}_{0} ) = {cos}^{2} ( \frac{1}{2} {φ}_{p} ) {cos}^{2} ( \vert {k}_{eo} \vert Δ z ) + \\ {sin}^{2} ( \vert {k}_{eo} \vert Δ z ) {cos}^{2} ( {φ}_{1} - \frac{1}{2} {φ}_{p} )\end{matrix} & \text{(14a)} \\ \begin{matrix}{P}_{2} ( L , {z}_{0} ) = {sin}^{2} ( \frac{1}{2} {φ}_{p} ) {cos}^{2} ( \vert {k}_{eo} \vert Δ z ) + \\ {sin}^{2} ( \vert {k}_{eo} \vert Δ z ) {sin}^{2} ( {φ}_{1} - \frac{1}{2} {φ}_{p} )\end{matrix} & \text{(14b)}\end{matrix}$$

where φₚ=φ(L)+Δφₚ, is the total perturbed phase difference between even and odd modes, expressed as the sum of the total phase difference between the even and odd modes of the unperturbed coupler

$$φ ( L ) = {\int }_{0}^{L} Δβ ( z ) ⅆ z$$

and perturbation term Δφ_{P}=(kₑₑ-kₒₒ)Δz. The term

$${φ}_{1} = {\int }_{0}^{{z}_{0}} Δβ ( z ) ⅆ z$$

is the accumulated phase difference up to the perturbation point and it is therefore a function of z₀. For a uniform coupler, φ₁ is the only z₀-dependent term. Therefore, by monitoring the power variation as the perturbation is scanned along the coupler length, it is possible to extract useful information about the coupler waist characteristics and the power evolution along the coupling region.

Two different types of perturbation can be considered, namely:

Symmetric types, where the perturbation is applied symmetrically with respect to power distribution of the even and odd eigenmodes. The lower part of FIG. 3(b) shows a specific arrangement of symmetric perturbation. From Equations (6), it can be deduced that in this case only the self-coupling coefficients kₑₑ and kₒₒ are non-zero while the cross-coupling coefficients kₑₒ and kₒₑ are zero.

Asymmetric types, where the perturbation is applied asymmetrically with respect to power distribution of the even and odd eigenmodes. The upper part of FIG. 3(b) shows a specific arrangement of asymmetric perturbation. In this case, both the self-coupling and cross-coupling coefficients are non-zero.

Considering further the situation of a symmetric perturbation, under the conditions of symmetric perturbation, Equations (14) become:

$${P}_{1} ( L ) = {cos}^{2} [ \frac{1}{2} {φ}_{p} ( L ) ] = {cos}^{2} \{ \frac{1}{2} [ φ ( L ) + {Δφ}_{p} ] \} \\ {P}_{2} ( L ) = {sin}^{2} [ \frac{1}{2} {φ}_{p} ( L ) ] = {sin}^{2} \{ \frac{1}{2} [ φ ( L ) + {Δφ}_{p} ] \} \qquad ( 15 )$$

In the case of an ideal multiple-cycle coupler of length L₀, the unperturbed total phase difference φ(L₀) is given by φ(L₀)=mπ where m=1,2,3, . . . In practice, however, couplers are usually slightly detuned from the ideal length and have a length L such that L≠L₀ and |L−L₀|<<1. This can arise from manufacturing errors or from distortion of the coupler in use. The unperturbed total phase difference φ(L), in this case, is given by φ(L)=φ(L₀)+Δφ_{L}=mπ+Δφ_{L}, where m=1,2,3, . . . and

$${Δφ}_{L} = {\int }_{{L}_{o}}^{L} Δβ ( z ) ⅆ z ⪡ π .$$

For multiple cycle full-cycle couplers, in which m is even, in the limit of small perturbation [(kₑₑ-kₒₒ)Δz<<1], equations (15) become:

$$\begin{matrix}{P}_{1} ( L ) \approx 1 - {( \frac{{Δφ}_{L} + {Δφ}_{p}}{2} )}^{2} \\ \approx 1 - \frac{1}{4} {Δφ}_{L}^{2} - \frac{1}{2} {Δφ}_{L} ( {k}_{ee} - {k}_{oo} ) Δ z\end{matrix} \\ {P}_{2} ( L ) \approx {( \frac{{Δφ}_{L} + {Δφ}_{p}}{2} )}^{2} \approx \frac{1}{4} {Δφ}_{L}^{2} + \frac{1}{2} {Δφ}_{L} ( {k}_{ee} - {k}_{oo} ) Δ z \qquad ( 16 )$$

For multiple cycle half-cycle couplers, in which m is odd, the expressions for P₁(L) and P₂(L) are interchanged.

From Equations (16), it can be seen that, in the case of symmetric perturbation, the power P₂ at the output of waveguide 2 (output port 4) has two contributions. In addition to the initial residual power, there exists another term that depends on the difference between the perturbation-induced self-coupling coefficients, and is owing to manufacturing tolerances and errors resulting in a small detuning Δφ_{L}≠0. Although the first contribution is fixed and independent of perturbation, the second contribution depends on the overlap between the profile of the perturbation induced by the perturbation element and the even and odd modes of the coupler waist. This overlap can be shown to depend on the coupler-waist radius and the perturbation penetration depth (see later). Under symmetric perturbation, the power variation at either output port (port 3 or port 4) can be used to map the coupling region outer diameter variation. It can, therefore, provide useful information about the taper-region shape and waist uniformity. In the case of non-uniform couplers, it can also provide the exact profile of the entire coupling region. In case of a perfect coupler (Δφ_{L}=0), the required information is given by the quadratic term [(kₑₑ-kₒₒ)Δz]². Note that, for an unperturbed full cycle coupler, all power should exit by the output port of waveguide 1 (port 3), but the induced perturbation causes power “leakage” at the output port of waveguide 2 (port 4).

Considering now the case of asymmetric perturbation, in the general case, all coupling coefficients are non-zero. For a slightly detuned coupler with m even (full cycle coupler), and an asymmetric perturbation applied at a position z₀ along the coupling region, Equations (14) take the form:

$$\begin{matrix}{P}_{1} ( {z}_{0} , L ) = {cos}^{2} ( \frac{1}{2} Δφ ) {cos}^{2} ( \vert {k}_{eo} \vert Δ z ) + \\ {sin}^{2} ( \vert {k}_{eo} \vert Δ z ) {cos}^{2} ( {φ}_{1} ( {z}_{0} ) - \frac{1}{2} Δφ )\end{matrix} \\ \begin{matrix}{P}_{2} ( {z}_{0} , L ) = {sin}^{2} ( \frac{1}{2} Δφ ) {cos}^{2} ( \vert {k}_{eo} \vert Δ z ) + \\ {sin}^{2} ( \vert {k}_{eo} \vert Δ z ) {sin}^{2} ( {φ}_{1} ( {z}_{0} ) - \frac{1}{2} Δφ )\end{matrix} \qquad ( 17 )$$

where Δφ=(Δφ_{L}+Δφ_{P}) is the total detuning due to length mismatch and the perturbation. For a small total detuning (Δφ<<π) and a small perturbation (|kₑₒ|Δz≈0), P₂ can be approximated by:

$${P}_{2} ( {z}_{0} , L ) \approx {( \frac{Δφ}{2} )}^{2} + {( \vert {k}_{eo} \vert Δ z )}^{2} {sin}^{2} ( {φ}_{1} ( {z}_{0} ) - \frac{Δφ}{2} ) \qquad ( 18 )$$

The first term of Equation (18) is the residual power at output port 4 due to the small total phase detuning and a non-zero difference between the symmetric perturbation coefficients (kₑₑ-kₒₒ). This term is similar to the one appearing under the symmetric perturbation of the coupler (Equation (16)). The second term depends on the relative position of the applied perturbation (through φ₁(z₀)) and the square of perturbation strength (through (|kₑₒ|Δz)²). From Equation (18) it is observed that for a small phase detuning the power evolution along the coupler is followed.

It can be shown that the leakage power P₂ acquires maximum values at positions Z₀ₙ along the coupling region, for which:

$${φ}_{1} ( {z}_{0 n} ) = \frac{1}{2} Δφ + ( 2 n + 1 ) \frac{π}{2} n = 0 , 1 , 2 \qquad ( 19 )$$

The total number of successive maxima is determined by the relation 0≦φ₁(z₀ₙ)≦mπ where m=2,4,6 . . . Equation (19) is also valid for multiple cycle half-cycle couplers where m is odd. In this case, however, the expressions for output powers P₁ and P₂ in Equations (17) are interchanged. For the related ideal coupler (where Δφ0), the corresponding P₂ maxima positions z′₀ₙ fulfil the relation φ₁(z′₀ₙ)=(2n+1)π/2. It can be shown that at these positions the total power is split equally between the waveguides, so that P₁=P₂ (50-50% points).

The leaking power P₂ acquires minimum values at the points where the perturbation term in (18) vanishes, i.e. when:

$${φ}_{1} ( {z}_{0} ) = \frac{1}{2} Δφ + n π n = 0 , 1 , 2 \qquad ( 20 )$$

For an ideal coupler (Δφ=0), at these minimum points the power is concentrated in only one of the waveguides (0-100% points).

As mentioned, couplers are frequently non-ideal, so that Δφ≠0. From equation (19) it can be deduced that the presence of a finite phase detuning (Δφ≠0) introduces an error in the determination of the position of the 50-50% points. Two causes of phase detuning are considered:

Maintaining the Coupler Strength and Varying the Coupler Length

For uniform couplers the error in the determination of the 50-50% points of the coupler at resonance (i.e. when the coupler is operated with its ideal, resonance, wavelength) owing to a phase detuning Δφ originated by varying the coupler length to L+ΔL while maintaining the strength of the coupler is given by:

$$Δ {z}_{n} = {z}_{0 n} - {z}_{0 n}^{′} = \frac{Δφ}{2 Δβ} = \frac{{Δφ}_{L} + {Δφ}_{p}}{2 Δβ} \qquad ( 21 )$$

where z₀ₙ are the actual 50-50% points of the ideal coupler and z′₀ₙ are the maxima of the non-ideal asymmetric perturbation. The error Δzₙ can be minimized by using probe light with a wavelength close to the resonance wavelength of the coupler, and using a very small perturbation. For example, for a full-cycle coupler (m=2) with 20 dB extinction ratio (Δφ_{L}=0.2) and a length of 30 mm, the error in the 50-50% point positions is ˜−0.5 mm.

Varying the Coupler Strength and Maintaining the Coupler Length

This situation arises when analyzing the coupler at a different wavelength (test wavelength, λₜ) from the resonance wavelength, λ₀. For full-cycle couplers, at the test wavelength λₜ, then Δβₜ=2π(nₑ-nₒ)/λₜ. At the resonance wavelength λ₀, then Δβ₀=2π(nₑ-nₒ)/λ₀. Assuming that λₜ is very close to λ₀, then (nₑ-nₒ) can be considered constant. The coupler phase displacement from the resonance is given by Δφ=(Δβₜ-Δβ₀)L where L is the length of the coupler. For a test wavelength of λₜ<λ₀, then Δφ>0, and if λₜ>λ₀, then Δφ<0. If the coupler is analyzed at the resonance wavelength then λₜ=λ₀ and Δφ=0. It can be shown that, for a uniform full-cycle coupler the error in the 50-50% points due to a phase detuning Δφ is given by:

$$Δ {z}_{( n = 0 )} = {z}_{0 ( n = 0 )} - {z}_{0 ( n = 0 )}^{′} = - \frac{Δφ}{4 {Δβ}_{t}} \\ Δ {z}_{( n = 1 )} = {z}_{0 ( n = 1 )} - {z}_{0 ( n = 1 )}^{′} = + \frac{Δφ}{4 {Δβ}_{t}} \qquad ( 22 )$$

where n=0,1 correspond to the first and second 50-50% point respectively and z₀ₙ corresponds to the position of the 50-50% point of the ideal coupler and z′₀ₙ are the maxima of the non-ideal asymmetric perturbation. It is interesting to note that the 0-100% point of the coupler corresponds to the minimum of the perturbation independently of the phase detuning Δφ. When calculating the error between the local minimum of the asymmetric perturbation given by Equation (20) and the position of the 0-100% point of the full-cycle coupler it is found that:

Δzₙ₌₁=z₀ₙ₌₁−z′₀ₙ₌₁=0 (23)

For a uniform half-cycle coupler the error in the 50-50% points due to a phase detuning Δφ is given by:

Δzₙ₌₀=z₀ₙ₌₀z′₀ₙ₌₀=0 (24)

Therefore, for a half-cycle coupler the maximum of the leaking power due to an asymmetric perturbation is a marker of the 50-50% point of the coupler independently of the phase detuning of the coupler i.e., independently of the test wavelength.

The discussion up to now has considered the effect of perturbations on the power of the transmitted probe light. Asymmetric perturbation of the coupler will also affect the phase of the electric field of the transmitted probe light at the output ports. The phase varies with the perturbation position along the coupler waist. The output phase is given by θ₁=arctan(Im(Aₜ)/Re(Aₜ)), where Aₜ(i=1,2) is the field amplitude at either output port. From Equation (10), and for a perfect full-cycle coupler (m=2, Δφ=0) the phase change at the output port of the perturbed coupler relative to the unperturbed coupler is given by:

θ₁(z₀)=arctan{−tan(|kₑₒ|Δz)·cos[φ₁(z₀)]} (25)

For small perturbations (kₑₒΔz˜0) the phase difference is approximated by:

$${θ}_{1} ( {z}_{0} ) \approx - 2 \vert {k}_{eo} \vert Δ z {cos}^{2} ( \frac{1}{2} {φ}_{1} ( {z}_{0} ) ) + \vert {k}_{eo} \vert Δ z \qquad ( 24 )$$

Recalling Equations (4) it can then be deduced that, with the perturbation applied at position z₀, the relative phase change of the field amplitude at output port 3 is proportional to the individual waveguide power P₁(z₀). Therefore, the change in the relative phase of the field at the coupler output maps directly the power evolution along the corresponding individual waveguide. This information can be used to calculate the coupling constant distribution k(z) along the coupling region. For a perfect full-cycle coupler (Δφ=0) no light arrives at port 4 and therefore the phase displacement cannot be measured at that port.

In the case of non-ideal full-cycle couplers with a slight phase detuning (m=2, Δφ≠0) the phase change at the output port due to the asymmetric perturbation of the coupler is given by:

$${θ}_{1} ( {z}_{0} ) \approx - \frac{Δφ}{2} + \vert {k}_{eo} \vert Δ z - 2 \vert {k}_{eo} \vert Δ z {cos}^{2} ( \frac{1}{2} {φ}_{1} ( {z}_{0} ) ) \\ {θ}_{2} ( {z}_{0} ) \approx \frac{Δφ}{2} ( 1 + \frac{1}{\vert {k}_{eo} \vert Δ z sin ( {φ}_{1} ( {z}_{0} ) )} ) \qquad ( 27 )$$

Therefore, for full-cycle couplers with a small phase detuning, the phase change at output port 3 continues to map the power evolution along the coupler. However, the phase change at output port 4 does not provide a direct measurement of the coupler power evolution, as shown in Equations (27).

Numerical Simulations

Overlap Integrals Between the Coupler Eigenmodes and the Perturbation Profile

As discussed above, analysis of couplers using symmetric and asymmetric perturbations allows the location of the 50-50% power points of the coupler and the measurement of the beat length and any radius non-uniformities in the taper region profile. The perturbations are induced by a perturbing element providing perturbing radiation, such as external heating elements or illumination by light sources (white light source, blackbody radiation source, CO₂ laser, He—Ne laser, laser diodes, light emitting diodes, superluminescent diodes etc). The various sources will induce different perturbation profiles and therefore will have a different overall effect.

In order to investigate the effectiveness of the perturbation a simplified phenomenological model has been used to calculate the relative magnitude of the coupling coefficients kᵢⱼ (i,j=e,o) under varying perturbing conditions. According to the model, a highly fused coupler waist is approximated by a circular cross-section (in the xy plane) silica structure with a negligible core. The coupler modes are approximated by the lowest order modes (LP₀₁ and LP₁₁) of this multimode cladding-air structure. The coupler is perturbed locally by radiation incident from a first side so as to give a symmetric perturbation or from a second side so as to give an asymmetric perturbation. The absorption of the radiation generates instantaneous heating of the structure that follows an exponential decay (˜e^{-αx}) through the waist. Therefore an exponential temperature gradient is induced. This results in a local change of the refractive index of the structure by Δn=(∂n/∂T)ΔT. For fused silica, the coefficient ∂n/∂T≈1.1×10⁻⁵ K⁻¹. For CO₂ laser radiation, a typical value for the absorption length is 1/α≈1 μm -6 μm, where α is the linear absorption coefficient.

The perturbation is quantified by calculating the overlap integrals OIᵢⱼ (i,j=e,o) between the temperature distribution and the eigenmode profiles. The overlap integrals are defined by:

$${OI}_{ij} = {\int }_{A} \int {E}_{i} {E}_{j} f ( x , y ) ⅆ A , i , j = e , o$$

where f(x,y) is the normalized temperature profile. The distribution f(x,y) is proportional to the perturbed index profile and, therefore, the overlap integrals OIᵢⱼ (ij=e,o) are proportional to the coupling coefficients kᵢⱼ (i,j=e,o).

First consider the effect of the radiation penetration depth on the coupling coefficient magnitude, for symmetric and asymmetric perturbation. The coupler waist radius is considered to be 16 μm, which is typical of the fiber coupler devices commonly fabricated with a flame brush technique.

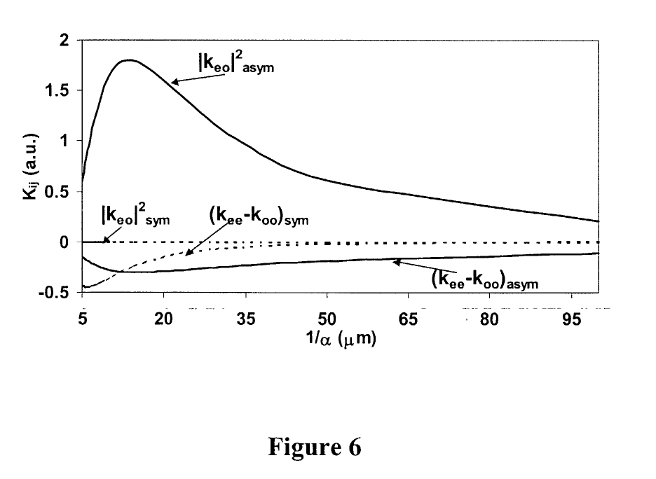

FIG. 6 shows plots of the relative variation (in arbitrary units) of the coupling coefficient kₑₒ and the corresponding difference in coefficients kₑₑ-kₒₒ (kᵢⱼ) for different radiation absorption lengths (1/α). The coupler waist radius is 16 μm. The dashed lines indicate symmetric perturbations and the solid lines indicate asymmetric perturbations. As previously described, under pure symmetric perturbation the perturbed output power is proportional to the difference kₑₑ-kₒₒ (see Equation (16)), while under pure asymmetric perturbation the perturbed power is proportional to kₑₒ² (see Equation 18). FIG. 6 indicates that both the asymmetric perturbation kₑₒ and the symmetric perturbation kₑₑ-kₒₒ are maximized for a range of absorption lengths between about 10 μm and 17 μm. Therefore, the perturbation method is optimized for these radiation absorption lengths, for the given coupler waist radius of 16 μm. FIG. 6 also indicates that asymmetric perturbations result in a finite kₑₑ-kₒₒ which nevertheless, is appreciably smaller than the accompanying kₑₒ. Under symmetric perturbation, as expected, kₑₒ is negligible for every absorption length. Also, as the absorption length is increased appreciably (so that it is much larger than the coupler radius) the perturbation becomes increasingly uniform through the entire coupler waist cross-section and all the parameters tend to zero, under either perturbation. This suggests that it is advantageous to use a perturbation radiation with an absorption length not significantly greater than the coupler waist size, so that the perturbation effect is optimized. For example, a helium-neon laser emits light at 633 nm which has an absorption length in silica of approximately 1 m, so is not suitable as perturbing radiation for the analysis of silica waveguides without the use of a thermally absorbing layer.

Now consider the effect of the coupler waist radius on the coupling coefficient magnitude, for symmetric and asymmetric perturbation. The perturbation radiation absorption length is taken to be 5 μm, typical for 10 μm CO₂ laser radiation in silica.

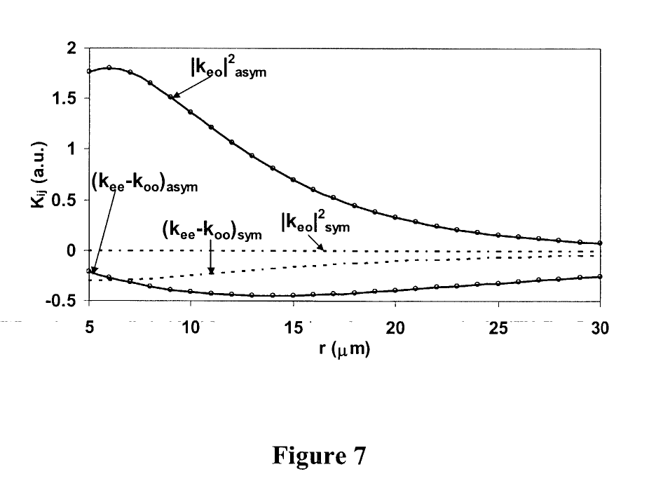

FIG. 7 shows plots of the relative variation (in arbitrary units) of the coupling coefficient kₑₒ and the corresponding difference in coefficients kₑₑ-kₒₒ (kᵢⱼ) for different coupler waist radii r. The dashed lines indicate symmetric perturbations and the solid lines indicate asymmetric perturbations. The asymmetric perturbation kₑₒ and the symmetric perturbation kₑₑ-kₒₒ are maximized for a coupler waist radius of about 5 μm, which is comparable to the given absorption length of 5 μm. FIG. 7 also shows that for small coupler waist radii, asymmetric perturbations result in kₑₑ-kₒₒ being appreciably smaller than the accompanying kₑₒ. However, for larger coupler-waist radii, the difference kₑₑ-kₒₒ becomes comparable with and finally equal to kₑₒ and the simple analytic formula of Equation (18) is not valid any more. In this case, the power perturbation at the coupler output should be calculated using Equations (14a) and (14b). Again, under symmetric perturbation, kₑₒ is zero for every coupler waist radius.

Furthermore, FIG. 7 shows that, under symmetric perturbation, the difference kₑₑ-kₒₒ changes quasi-linearly with the coupler waist radius. From Equation (16), it is then clear that the output power perturbation will follow closely the coupler waist outer dimensions as the perturbing laser is scanned along the coupling region.

The output power variation can therefore provide a reliable mapping of the entire coupling region giving a reasonably accurate estimation of the coupler uniformity.

Under asymmetric perturbation, the coupling coefficient kₑₒ changes appreciably with the coupler waist radius. From Equation (18), it can be deduced that as the perturbation is scanned along the coupling region, in addition to the expression in parentheses of the second term, the perturbation output power is appropriately weighted by the varying kₑₒ² coefficient. In addition, if kₑₑ-kₒₒ is larger or comparable to kₑₒ² (for large coupler waist radii or under weak CO₂ laser power), the significant kₑₑ-kₒₒ term in Equation (18) should also be taken into account.

A particularly significant point to note from the models presented in FIGS. 6 and 7 is the relative sizes of the coupler radius and the perturbation radiation absorption length. In FIG. 6, the coefficients are maximized for absorption lengths of about 10 to 17 μm when the coupler radius is 16 μm, i.e. when the radius is equal to or very similar to the absorption length. In FIG. 7, the coefficients are maximized for coupler radii of about 5 μm when the radiation absorption length is also 5 μm, once again, when the radius is equal to or very similar to the absorption length. Naturally, it is desirable to maximize the coefficients to optimize signal strength, but FIGS. 6 and 7 indicate that meaningful results can still be obtained when the coupler radius and the radiation absorption length differ somewhat, provided that a sufficient signal-to-noise ratio can be obtained.

The model deals with a coupler of circular cross-section having a waist radius, but the conclusions drawn from FIGS. 6 and 7 are equally applicable to couplers of other shapes. Therefore, in terms of the half-width of the coupling region rather than a radius, the absorption length of the perturbing radiation in the coupling region may be between 0.1 and 7 times the half-width of the coupling region in different examples. To increase the size of the coupling coefficients, the range of absorption lengths can be reduced to, for example, between 0.3 and 3 times the coupling region half-width, or between 0.4 and 2.2 times the coupling region half-width, or between 0.5 and 1.8 times the coupling region half-width, or between 0.56 and 1.5 times the coupling region half-width, or between 0.6 and 1.2 times the coupling region half-width, or between 0.8 and 1 times the coupling region half-width.

In some coupler geometries, the waveguides are not located centrally in the coupling region. A planar waveguide, for example, may have waveguides situated at or just below a surface in one dimension, but far from a surface in an orthogonal dimension. For the analysis of such couplers, the relevant distance to be considered when selecting perturbing radiation with an appropriate absorption length is not necessarily the half-width of the coupling region, but the distance between the waveguide or waveguides and the coupling region surface through which the perturbing radiation is incident. In all cases, regardless of coupler geometry, the absorption properties of all materials through which the perturbing radiation passes should be considered. For example, the coupler may have a cladding material which is transparent to the perturbing radiation so that the cladding thickness can be ignored when considering the absorption length relative to the depth of the waveguide below the coupler surface. Therefore, the term “coupling region half-width” and corresponding terms are to be interpreted in accordance with the geometry of the coupler being analyzed.

Overall, it can be concluded that useful results can be obtained if the absorption length of the perturbing radiation in the coupling region is preferably comparable to the half-width of the coupling region.

The model also considers the effect of different incident radiation powers on the magnitude of the coefficients kₑₑ-kₒₒ and kₑₒ² under asymmetric perturbation.

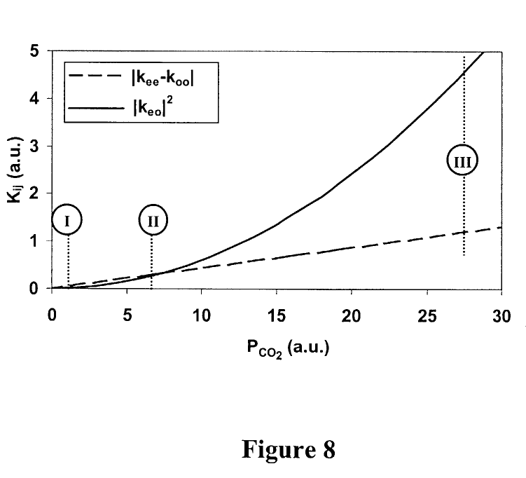

FIG. 8 shows plots of the variation of the coupling coefficients kᵢⱼ for asymmetric perturbations induced by different perturbing laser powers P_{CO2.} The solid line shows the variation of kₑₒ² and the broken line shows the variation of kₑₑ-kₒₒ. It is assumed that there is a linear dependence of the refractive index with the power of the incident radiation and therefore, the coupling coefficients (kₑₑ-kₒₒ) and kₑₒ are proportional to the power of the incident radiation. The absorption length of the incident radiation was 5 μm (CO₂ laser radiation) and the coupler waist radius was 16 μm. For high powers of the CO₂ laser (Region III in FIG. 8), kₑₑ-kₒₒ<<kₑₒ² and the asymmetric perturbation of the coupler can be used to locate the 50-50% points of the coupler. For small values of the CO₂ laser power where kₑₑ-kₒₒ>>kₑₒ or kₑₑ-kₒₒ≈kₑₒ (Regions I and II in FIG. 8 respectively) the first term in Equation (18) should be taken into account.

This behavior indicates that by varying the incident power of the perturbing radiation, the coupler can be completely analyzed under asymmetric perturbation. High incident powers permit the location of the 50-50% points and the measurement of the power distribution, whereas low incident powers produce the same effect as a symmetric perturbation, so that the coupling profile can be mapped.

Coupler Perturbation Modeling

In order to verify the approximate results given by Equations (16) and (18), an exact model based on the transfer-matrix method was implemented. The entire coupler was divided in M uniform sections and the transfer matrices corresponding to each section were calculated using Equations (8) to (10). The transfer matrix of the entire coupler was then calculated by multiplying the individual transfer matrices. No simplifications to the perturbation matrix were made. In this model, any coupling profile k(z) can be introduced and both symmetric and asymmetric perturbations can be accounted for by modifying the values of the coupling coefficients kₑₒ, kₒₑ and kₒₒ A number of different coupler configurations were considered with coupling coefficient profiles of varying complexity. The modeling is intended to demonstrate that for all coupling coefficient geometries, an asymmetric perturbation scanned along the coupling region always provides the 50-50% power points. The following simulations consider an ideal asymmetric perturbation with only the perturbation coefficient kₑₒ being non-zero.

Uniform Coupler

The first simulation refers to an ideal uniform coupler with constant coupling coefficient throughout the coupling region. The total coupler region length is L=30 mm. The total phase difference between the even and odd eigemnodes is φ(L)−2π(full-cycle coupler).

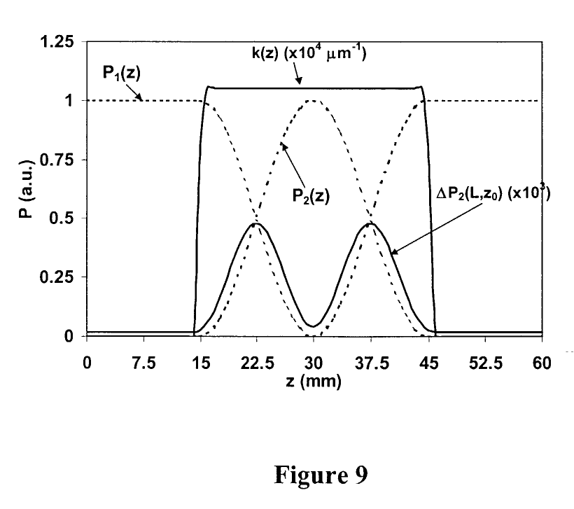

FIG. 9 shows the power evolution of P₁(z) and P₂(z) of each “individual” waveguide (dashed lines) and the output power perturbation ΔP₂(L) (solid line) expressed as normalized power P, as functions of the perturbation position z along the coupling region. The coupling coefficient profile k(z) is also superimposed for better visualization.

These results illustrate that the positions along the coupler region where the output power perturbation ΔP₂(L) is maximized correspond to the points where the power is equally distributed between the two “individual” waveguides (P₁(z)=P₂(z)=0.5). For an ideal uniform coupler of length L, these points are situated at L/4 and 3L/4. The simulation results show that the 50-50% points are at 7.5 mm from the center of the coupler, as expected.

Uniform Coupler with Two Tapered Regions

The second simulation refers to a more realistic coupler profile with a taper region on either side of the uniform coupler waist. Each taper region is 10 mm long and the uniform waist region is 30 mm long. The total coupler length is therefore L=50 mm. Again, the total phase difference between the even and odd eigemnodes was φ(L)=2π (full-cycle coupler). This coupling profile is typical of couplers fabricated with the flame brush technique.

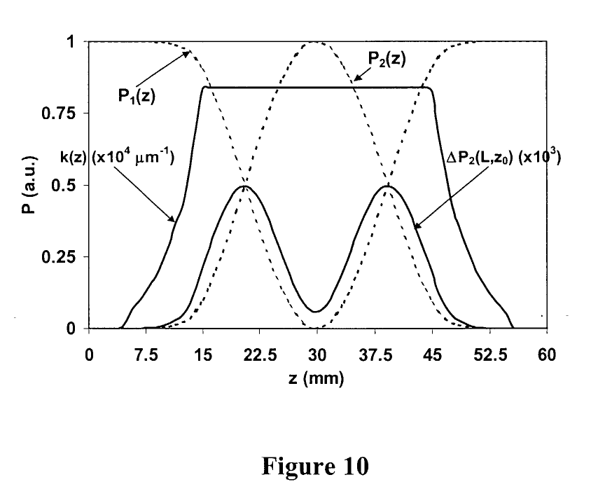

FIG. 10 shows the power evolution of P₁(z) and P₂(z) of each “individual” waveguide (dashed lines) and the output power perturbation ΔP₂(L) (solid line) expressed as normalized power P, as functions of the perturbation position z along the coupling region. The coupling coefficient profile k(z) is also superimposed for better visualization.

These results show that the effect of the taper regions on the power distribution along the coupler is to move the 50-50% points away from the center of the coupler. This is caused by some coupling between the modes in the taper regions. The results also illustrate that the maxima of the output perturbation power coincide with the 50-50% points, which are placed 9.5 mm away from the center of the coupler.

Uniformly Tapered Couplers

Examples of non-uniform couplers were also modeled. A coupler having a uniformly tapered coupling coefficient profile with a small taper ratio was studied. This type of profile can be encountered in real fused couplers and may be caused by temperature non-uniformities along the fused waist or by other experimental inaccuracies. A uniformly tapered coupler with an extreme taper ratio was also studied. In both cases, the total coupler length was L=30 mm and the total phase difference between the even and odd eigenmodes was φ(L)=2π(full-cycle coupler).

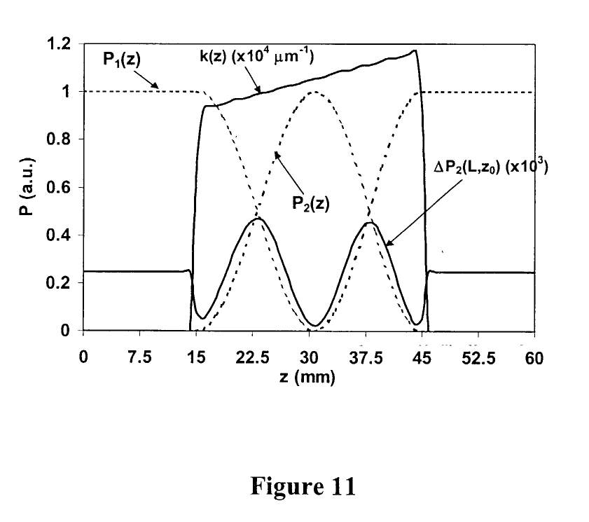

FIG. 11 relates to the coupler with the small taper ratio, and shows the power evolution of P₁(z) and P₂(z) of each “individual” waveguide (dashed lines) and the output power perturbation ΔP₂(L) (solid line) expressed as normalized power P, as functions of the perturbation position z along the coupling region. The coupling coefficient profile k(z) is also superimposed for better visualization.

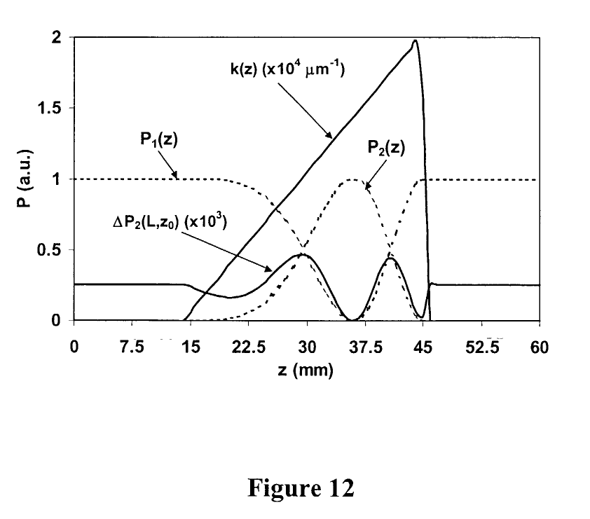

FIG. 12 relates to the coupler with the extreme taper ratio, and shows the power evolution of P₁(z) and P₂(z) of each “individual” waveguide (dashed lines) and the output power perturbation ΔP₂(L) (solid line) expressed as normalized power P, as functions of the perturbation position z along the coupling region. The coupling coefficient profile k(z) is also superimposed for better visualization.

Despite the different individual power distributions, in both cases the output power perturbation maxima coincide with the points along the coupler where the power is split equally between the two “individual” waveguides (P₁(z)=P₂(z)=0.5).

Non-Uniform Coupler (Mach-Zehnder Interferometer)

The final simulation concerns a complex non-uniform coupling structure comprising two weakly-coupled regions and an intermediate uncoupled region. The length of each weakly-coupled region is L₀=10 mm and the total coupler length L_{c}=30 mm. The phase difference between the even and odd eigenmodes along each weakly-coupled region is

$${\int }_{0}^{{L}_{0}} Δβ ( z ) ⅆ z = \frac{π}{2} .$$

The total phase difference between the even and odd eigenmodes is

$$φ ( {L}_{c} ) = {\int }_{0}^{{L}_{c}} Δβ ( z ) ⅆ z = π$$

(half-cycle coupler). Since the coupler is a half-cycle long, the perturbation is measured at the output of waveguide 1.

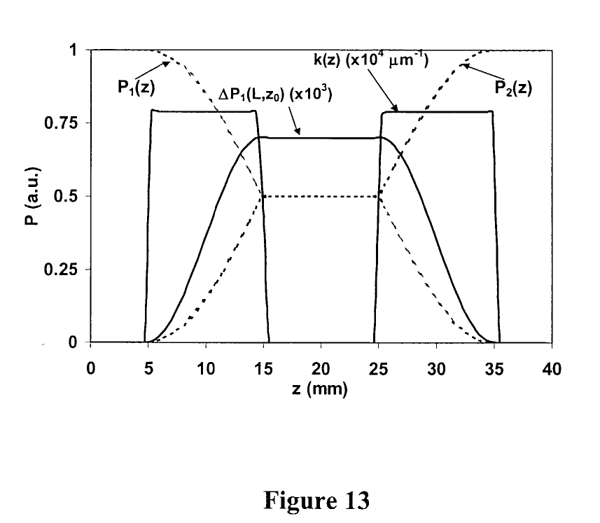

FIG. 13 shows the power evolution of P₁(z) and P₂(z) of each “individual” waveguide (dashed lines) and the output power perturbation ΔP₂(L) (solid line) expressed as normalized power P, as functions of the perturbation position z along the coupling region. The coupling coefficient profile k(z) is also superimposed for better visualization.

At the end of the first weakly-coupled region, the power is equally split between the “individual” waveguides 1 and 2 (P₁=P₂). The powers remain unchanged over the central uncoupled region and cross-couple completely at the end of second weakly-coupled region. The output power perturbation ΔP₁(L) (solid line) maps exactly this power evolution. It is shown that ΔP₁(L) reaches a maximum value when the perturbation reaches the end of the first weakly-coupled region and retains it over the entire uncoupled central region, where the power is split 50-50%. This complex coupled structure corresponds to a Mach-Zehnder interferometer (which may be considered as two serially connected couplers).

Perturbations of Non-ideal Couplers

As already mentioned, in the presence of a finite detuning Δφ the perturbation power maxima are displaced from the actual 50-50% power points by an amount given by Equation (21) or Equation (22) depending on the nature of the phase detuning.

Maintaining the Coupler Strength and Varying the Coupler Length of a Full Cycle Coupler

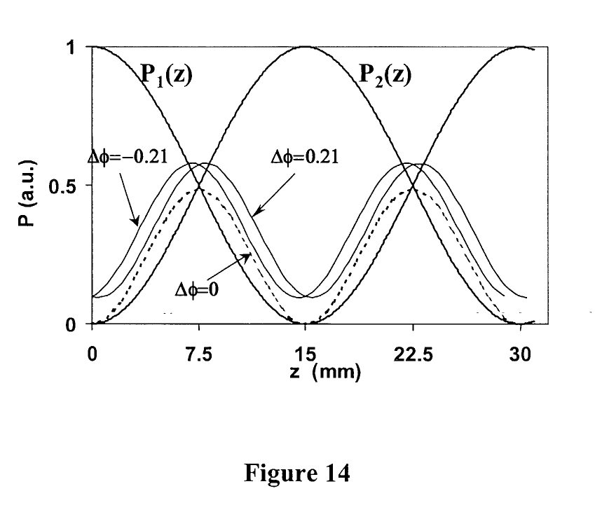

FIG. 14 shows plots of the variation of normalized power P with perturbation position z along the coupling region for a simulation of the asymmetric perturbation of couplers with different phase displacements from the optimum point, Δφ_{L}=0, the phase displacements being ±0.21 (Δφ_{P} is considered 0). The coupling strength was kept constant and the phase displacement, Δφ_{L}, was achieved by varying the coupler length by ΔL_{coupler}=Δφ₁/Δβ=±1.0 mm. The length of the ideal coupler (Δφ_{L}=0) was L=30 mm and the coupling strength of all the couplers was Δβ=2.π/L. The cross-coupling coefficient remained constant, kₑₒΔz=0.22 and (kₑₑ-kₒₒ)=0. The perturbation powers are multiplied by a factor of 10.

The thick solid lines show the power evolution P₁(z) and P₂(z) in the “individual” waveguides along the coupler length. The dashed line shows the asymmetric perturbation of an ideal coupler (Δφ=0), and the thin solid lines show the corresponding perturbations of the detuned couplers (Δφ_{L}=−0.21 and Δφ_{L}=+0.21. The shifts in the perturbation maxima from the ideal case (see equation 21) are evident. It is noted that with the negative phase displacement, both maxima shift towards the input end of the coupling region, whereas for the positive displacement both maxima shift towards the output end of the coupling region.

For a uniform 2π coupler with a coupling strength of Δβ=2π/L where L=30 mm is the optimum coupler length and for a phase displacement of Δφ_{L}=±0.21, the correction to the perturbation maxima positions, in order to obtain the 50-50% points of the coupler is given by Equation (21) as

$$Δ {L}_{pert} = \frac{Δφ \cdot L}{4 π} \approx \pm 0.5 mm .$$

Varying the Coupler Strength and Maintaining the Coupler Length of a Full Cycle Coupler

In the simulations of this form of phase detuning, the coupling length remained constant and the phase displacement, Δφ, was achieved by varying the difference between the coupler eigenmodes by Δφ/L. As already mentioned, this phase detuning occurs if a coupler is analyzed at a wavelength different from its resonance wavelength.

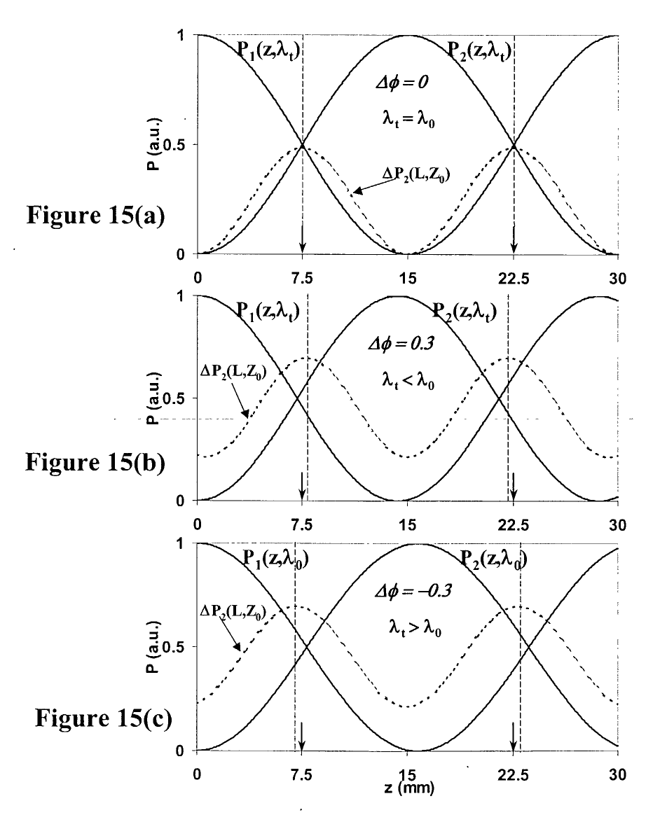

FIGS. 15(a), (b) and (c) show plots of the variation of normalized power P with perturbation position z along the coupling region for a simulation of the asymmetric perturbation of a uniform full cycle coupler analyzed with different probe wavelengths. In these simulations the difference between the eigenmodes of an ideal coupler (Δφ=0) was Δβ=(2.π/L and the difference between the eigenmodes of detuned couplers was Δβ=2.π+Δφ)/L. The length of all couplers was L=30 mm, the cross-coupling coefficient remained constant so that kₑₒΔz=0.22, and kₑₑ-kₒₒ=0. The perturbation powers are multiplied by a factor of 10.

FIG. 15(a) shows the results of analysis of an ideal coupler (Δφ=0) with a probe wavelength λₜ equal to the resonance wavelength λ₀. As expected, the maxima of the perturbation power ΔP₂ (dashed line) occur at the 50-50% points, where the powers P₁ and P₂ (solid lines) in the individual waveguides are equal. The vertical dashed lines correspond to the maxima positions, which are marked on the horizontal axis by arrows. This should be compared with FIGS. 15(b) and 15(c), which show the errors in the maxima position which arise from analysis at λₜ≠λ₀. FIG. 15(b) relates to analysis at λₜ<λ₀, which gives a positive phase displacement (Δφ=0.3), and FIG. 15(c) relates to analysis at λₜ>λ₀, which gives a negative phase displacement (Δφ=−0.3). In both graphs, the positions of the maxima in the perturbed power are shown by the vertical dashed lines, and the arrows on the horizontal axis mark the maxima positions for the ideal coupler of FIG. 15(a), i.e. the actual 50-50% points of the coupler.

It can be seen from FIGS. 15(b) and 15(c) that for the cases of the detuned couplers, the positions of the asymmetric perturbation maxima differ from the actual 50-50% points of the ideal coupler, as marked by the arrows (which also differ from the 50-50% points of the detuned couplers). In accordance with Equation (22) the perturbation maxima in these cases are shifted inside (Δφ>0) or outside (Δφ<0) of the actual 50-50% points. Note the difference in behavior here, where the maxima shift towards or away from one another, from that discussed above for a coupler length detuning, in which the maxima shift in the same direction. Both the magnitude and the direction of the shift should be correctly accounted for in order for the actual 50-50% points to be retrieved. It should also be stressed that in all cases the 0-100% point (given by the asymmetric perturbation minimum) remains fixed as predicted by Equation (23) of the theory.

For a uniform full cycle 2π coupler with a length L=30 mm, where Δβ=2π/L is the optimum coupling strength and for a phase displacement of Δφ=±0.3, the correction to the perturbation maxima positions, in order to obtain the 50-50% points of the ideal coupler, are given by,

$$Δ {L}_{1} = - \frac{Δφ \cdot L}{4 \cdot ( 2 π + Δφ )} and Δ {L}_{2} = + \frac{Δφ \cdot L}{4 \cdot ( 2 π + Δφ )} .$$

It can be seen that the corrections are different for Δφ=+0.3 (ΔL₁≈−0.34 mm and ΔL₂≈+0.34 mm) and Δφ=−0.3 (ΔL₁≈+0.38 mm and ΔL₂≈−0.38 mm).

Varying the Coupler Strength and Maintaining the Coupler Length of a Half-cycle Coupler

Similar modeling was carried out on a half-cycle coupler, in which the phase displacement was varied by altering the probe wavelength λₜ. In these simulations the difference between the eigenmodes of an ideal coupler (Δφ=0) was Δβ=π/L and the difference between the eigenmodes of detuned couplers was Δβ′=(π+Δφ)/L. The length of all couplers was L=30 mm, the cross-coupling coefficient remained constant so that kₑₒΔz=0.22, and (kₑₑ-kₒₒ)=0. The perturbation powers are multiplied by a factor of 10.

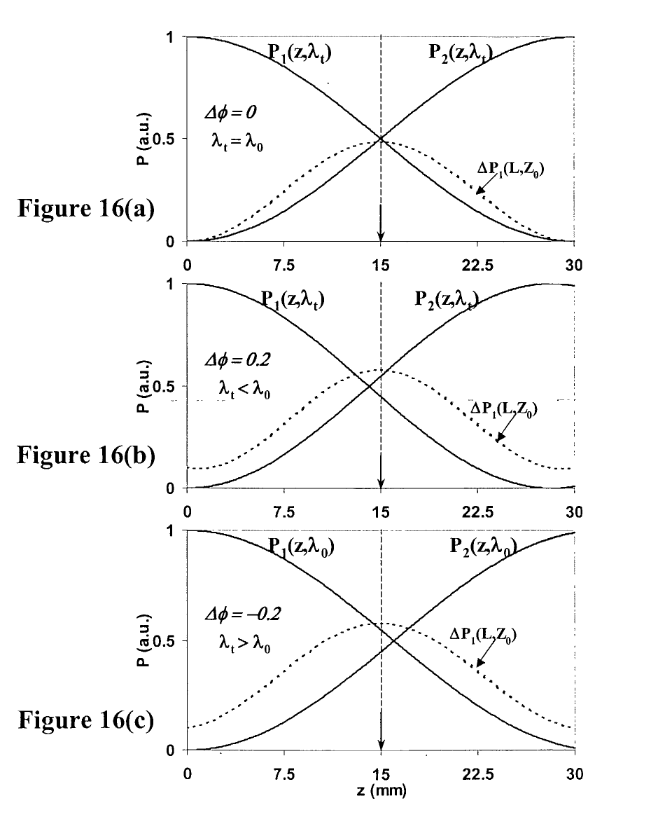

FIGS. 16(a), 16(b) and 16(c) shows the results of the simulations as plots of normalized power P against perturbation position along the coupling region z. In each case the solid lines show the power evolution in the individual waveguides, P₁ and P₂, and the dotted line shows the asymmetric perturbed power at the output of waveguide 1, ΔP₁. The vertical dashed line marks the position of the perturbed power maxima in each case, and the arrow on the horizontal axis marks the actual 50-50% position of the ideal coupler.

FIG. 16(a) shows the results for an ideal coupler (Δφ=0) tested at the resonance wavelength (λₜ=λ₀). As expected, the vertical dashed line shows that the position of the asymmetric perturbation maximum coincides with the actual 50-50% point of the coupler as shown by the arrow.

FIGS. 16(b) and 16(c) show the results obtained for the same coupler tested at the wavelengths λₜ<λ₀ (Δφ=0.2) and λₜ>λ₀ (Δφ=−0.2) respectively. The vertical dashed lines indicate that the asymmetric perturbation maximum still coincide with the actual 50-50% point of the ideal coupler as marked by the arrows, as predicted by Equation 24 of the theory.

The correction to the position of the maximum of the asymmetric perturbation of a half-cycle coupler (given by Equation (24)) is zero and therefore it is a marker to the 50-50% point of the half-cycle coupler independently of the coupling strength of the coupler or equivalently, independently of the wavelength at which the coupler is analyzed, as long as Δφ=<<π.

Output Phase Perturbation

It has been shown analytically that for a perfect coupler under pure asymmetric perturbation (Δφ=0), the phase of the electric field at the output port with non-null power, as given by Equation (25), is proportional to the power in the corresponding “individual” waveguide at the point of the perturbation. Therefore, the output phase variation maps directly the power evolution along the corresponding “individual” waveguide.

The phase change owing to an asymmetric perturbation was simulated for an ideal uniform full-cycle coupler (Δφ_{L}=0) by using Equation (12). The asymmetric cross-coupling coefficient was kₑₒΔz=0.07 and the self-coupling coefficients were considered zero (kₑₑ=kₑₑ=0).

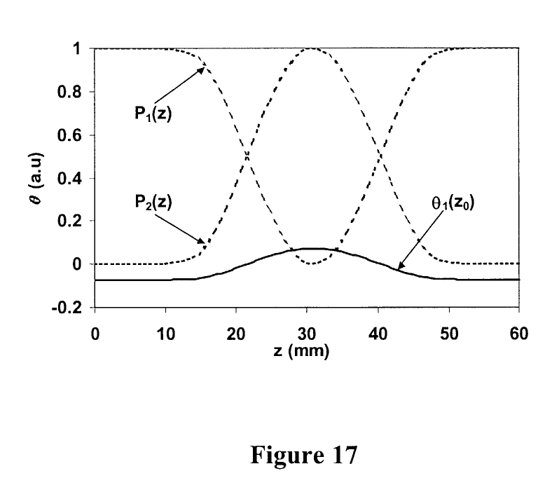

FIG. 17 shows the results of the simulation, as a plot of phase variation θ against perturbation position along the coupling region z. The solid line in the phase variation θ₁ at the output of waveguide 1, and the two dashed lines show the power evolutions P₁ and P₂ in the “individual” waveguides. These results indicate that the phase variation θ₁ of the electric field at the output of the “individual” waveguide 1 follows closely the power evolution P₁ along the corresponding “individual” waveguide. Therefore, for an optimum full cycle coupler (Δφ_{L}=0) with probe light launched into an input port of one of the waveguides, the coupling profile k(z) can be obtained by measuring the output phase at the output port of the same waveguide. The output phase changes can be accurately measured by using any phase sensitive (interferometric) technique.

Thus the numerical simulations show that the methods of the present invention can be applied to a wide range of coupler geometries to successfully determine the 50-50% points the 0-100% points, the power distribution, the power evolution and the coupling profile.

The theoretical analysis and numerical modeling presented thus far has been presented in terms of both full-cycle couplers (in which the phase variation along the coupling region is from 0 to an even multiple of π) and half-cycle couplers (in which the phase variation is from 0 to an odd multiple of π). In each case, all data, results and conclusions are equally applicable to both single cycle full-cycle couplers (0 to 2π) and multiple cycle full-cycle couplers (0 to 4π, 6π, etc.), and to both single cycle half-cycle couplers (0 to π) and multiple cycle half-cycle couplers (0 to 3π, 5π, etc.).

Also, other types of coupler can be analyzed, such as quarter cycle couplers, in which the phase variation is from 0 to an odd multiple of π/2. In the case of quarter cycle couplers, these can be treated for analysis as half cycle couplers that are far from resonance.

Experimental Results

A number of different experimental results have been obtained which verify the theory and numerical simulations. All results were obtained with an apparatus according to FIG. 1. All couplers analyzed were silica fiber couplers. The perturbations were induced by scanning the output of a CO₂ laser at 10.6 μm across the waists of the couplers. The technique proved to be stable, repeatable and accurate. In order to measure the perturbation, the CO₂ laser output was modulated and the power oscillations due to the perturbation were detected and amplified using a lock-in amplifier. The probe light was obtained from a (distributed feed-back) DFB laser diode generating 1.55 μm radiation, and was launched into port 1 of the coupler. Transmitted probe light arriving at port 3 and port 4 was detected and amplified using the lock-in amplifier. A mirror was mounted on a translation stage in order to scan the CO₂ laser output across the coupler waist. Symmetric perturbations were induced in the coupling region by shining the CO₂ laser beam perpendicularly to the plane of the two cores of the optical fibers comprising the coupler and perpendicularly to the optical axis of the coupling region. Asymmetric perturbations were accomplished by rotating the coupler by 90° around its longitudinal axis so that the CO₂ laser beam was parallel to the plane of the two cores and perpendicular to the optical axis of the coupling region.

Several experiments were performed. Three different couplers were fabricated and analyzed using the perturbation method: a half-cycle coupler (φ(L)=π), a full-cycle coupler (φ(L)=2π) and a complex non-uniform coupler. The length of the coupling regions of the couplers was 30 mm, with long transition regions making the total length of the fused regions approximately twice that. Both symmetric and asymmetric perturbations were used to analyze the couplers.

Analysis of Half-cycle Coupler [φ(L)=π]

Single cycle half-cycle couplers transfer light from one waveguide to the other, so that light that is launched into port 1 exits at port 4. They have one point where the power is equally distributed in both waveguides, which should be localized in the center of the coupler. Under asynmmetric perturbation, the perturbed power will peak once at this 50-50% point.

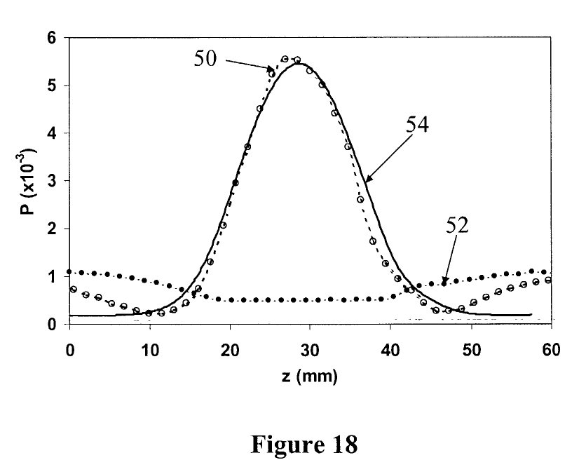

FIG. 18 shows results of the analysis of a π coupler, as plots of normalized power P against perturbation position z. The dotted line with open circles (labeled 50) shows the measured perturbed power resulting from an asymmetric perturbation. The dotted line with filled circles (labeled 52) shows the measured perturbed power resulting from a symmetric perturbation. The solid line (labeled 54) shows a theoretical fit of the asymmetric perturbation, obtained by normalizing the measured symmetric perturbation to π and using this as the coupling profile for the calculation. The fit of the asymmetric perturbation shows excellent agreement with the measured results.

The asymmetric perturbation follows the power distribution along the coupler, with the maximum marking the 50-50% point, and the symmetric perturbation follows the coupling profile. Although the symmetric perturbation follows the difference between the self-coupling perturbation coefficients, kₑₑ-kₒₒ, it will closely match the coupling profile, k(z) of the measured coupler, differing primarily in the tapered regions.

As discussed, the position of the maximum of the perturbed power due to an asymmetric perturbation is a marker for the 50-50% point of a half-cycle coupler independently of any small phase detuning of the coupler (either due to strain in the mounting of the coupler or analysis at a probe wavelength different from the coupler resonance wavelength). This information is very useful since the 50-50% points of half-cycle couplers can therefore be always obtained by using a normal laser diode to provide the probe light to analyze the coupler, without the need for a tunable laser set to the coupler exact resonance wavelength. Also, there is no need to calculate mathematical corrections. This was verified by measuring the asymmetrically perturbed power transmitted by a half-cycle coupler for three different probe wavelengths. A tunable laser was used to launch probe light into the coupler input port 1. Three different test wavelengths where used: λ₁=1510 nm, λ₂=1550 nm (coupler resonance wavelength) and λ₃=1590 nm. The power of the CO₂ laser was kept the same for all the experiments (100 mW through a 2 mm pinhole).

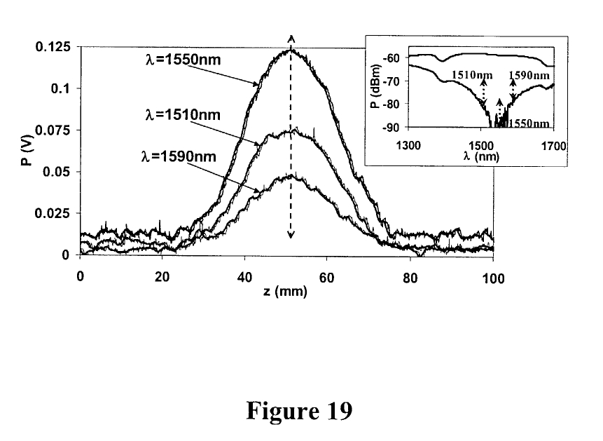

FIG. 19 shows the results of this experiment, as plots of measured perturbed power P against perturbation position z. From FIG. 19 it is evident that for a half-cycle coupler the position of the maximum of the power perturbation at output port 4 owing to an asymmetric perturbation of the coupler remains the same for different probe wavelengths. The difference in the magnitude of the perturbation at the different wavelengths is caused by differences in the tunable laser output power at the three wavelengths. The graph inset in FIG. 19 is the measured spectral response (power P against wavelength λ) of the coupler, with the three probe wavelengths marked.

Analysis of Full-cycle Coupler [φ(L)=2π]

As has been shown theoretically (see FIG. 9), the asymmetric perturbation of a single cycle full-cycle coupler has two maxima that correspond to the positions of the 50-50% power points of the coupler. A single cycle full-cycle coupler was fabricated and analyzed using both a symmetric perturbation and an asymmetric perturbation.

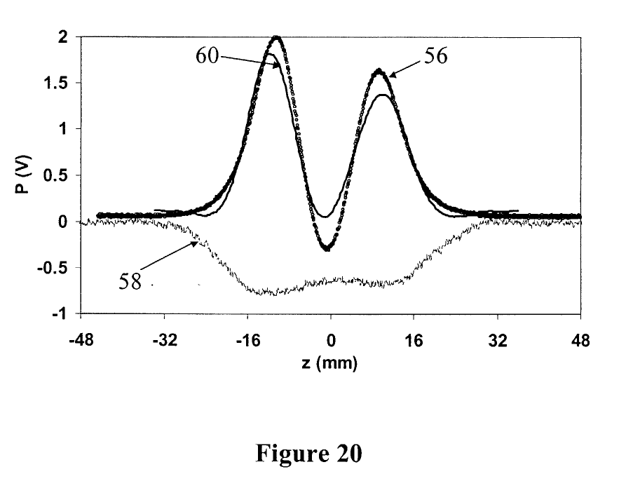

FIG. 20 shows the result of the analysis, as plots of power P against perturbation position z. The open circles show the measured asymmetric perturbed power (labeled 56), the dashed line shows the measured symmetric perturbed power (labeled 58), and the solid line shows a theoretical fit for the perturbed power (labeled 60). As for the case of the half-cycle coupler, the coupling profile obtained from the symmetric perturbation was used to obtain the theoretical fit for the asymmetric perturbation response. The asymmetric perturbation was fitted assuming a linear variation of 5% in the asymmetric coupling coefficient from waist end to waist end. The mean value was taken to be kₑₒ=2.3×10⁻⁴ μm⁻¹.

The experimental and theoretical results are in good agreement. The symmetric perturbation resulted in a very weak signal, which was therefore noisy after amplification. As expected, the experimental asymmetric perturbation has two peaks in the power of the perturbation. However, there is a slight difference in the height of the two peaks, which is accompanied by a corresponding variation in the symmetric perturbation signal. This could be caused by a small variation of the coupler waist outer diameter, or a slight twist in the coupler waist. A small misalignment between the coupler waist and the scanning CO₂ laser could also produce similar anomalies.

A 2π full-cycle coupler was analyzed using different CO₂ laser powers. This was done to demonstrate the theory (illustrated in FIG. 8) that a low level of asymmetric perturbation gives a perturbed power that follows the coupling profile, and a high level of asymmetric perturbation gives a perturbed power that follows the power distribution. The laser output powers used were 30 mW, 42 mW and 96 mW. The actual power that illuminated the fiber was much lower, given approximately by the ratio of outer waist diameter (≈30 μm) over the unfocused laser spot size (≈4 mm), which is 7.5×10⁻³. To reduce the spot size of the CO₂ laser and increase the resolution of the method, a 1 mm aperture was used, which reduced the power hitting the coupler to 1.87×10⁻³ of the output power.

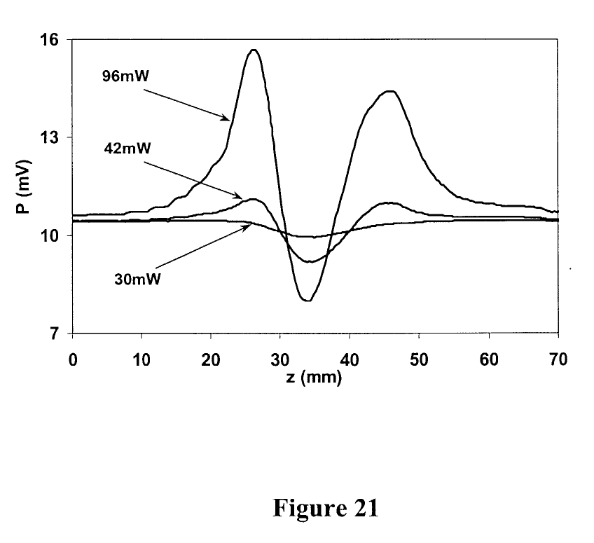

FIG. 21 shows the results of this experiment, as plots of perturbed power P against perturbation position z. The measured asymmetric perturbed power for each CO₂ laser output power is shown. For a C)₂ laser power of 30 mW, the asymmetric perturbation seems to follow the coupling profile of the structure and no maxima (50-50% points) are observed. This situation corresponds to Region I in FIG. 8. By increasing the power to 42 mW, an intermediate response is observed, where two perturbation maxima begin to appear, as predicted. Also, the coupling profile effect is stronger due to the increase of the (kₑₑ-kₒₒ) coefficient. At this power level, the magnitude of the coefficients (kₑₑ-kₒₒ) and kₑₒ² is comparable (corresponding to Region II of FIG. 8). For a larger power of the CO₂ laser (96 mW), the kₑₒ coefficient is predominant and the power distribution in the coupler is followed (corresponding to Region III of FIG. 8). The required correction to the positions of the 50-50% points of the coupler in relation to the maxima of the observed asymmetric perturbation, caused by a phase detuning of the coupler and the (kₑₑ-kₒₒ) coefficient, can be determined by Equation (22).

From FIG. 21 it is observed that when using an asymmetric perturbation, there is a threshold in the CO₂ laser power above which the power distribution of the coupler can be mapped and the 50-50% positions identified. Below this threshold, the coupling profile can be mapped instead. Therefore, a coupler can be fully analyzed with asymmetric perturbation, without the need to use symmetric perturbation. To achieve this, the analysis can comprise monitoring the transmitted probe light for an asymmetric perturbation induced by a first perturbation power and then monitoring the transmitted probe light for an asymmetric perturbation induced by a second perturbation power, where one of the powers is above the threshold and the other is below the threshold. This can be advantageous if the analyzing apparatus is such that it is more straightforward to modify the incident power of the perturbing radiation than to alter the relative positions of the coupler and the perturbing radiation to induce a symmetric perturbation.

Analysis of a Complex Non-uniform Half-cycle Coupler

A complex non-uniform coupler with three interaction regions each having a length of 10 mm, was fabricated using a flame brush technique. The theoretical coupling profile of the coupler was similar to that shown in FIG. 13. However, the actual coupler had transition taper region between each of the three interaction regions, and the width of the burner flame (approximately 4 mm) used in fabrication influenced the shape of the real structure, tending to average out the coupling profile. Both symmetric and asymmetric perturbations were carried out in the analysis of this coupler.

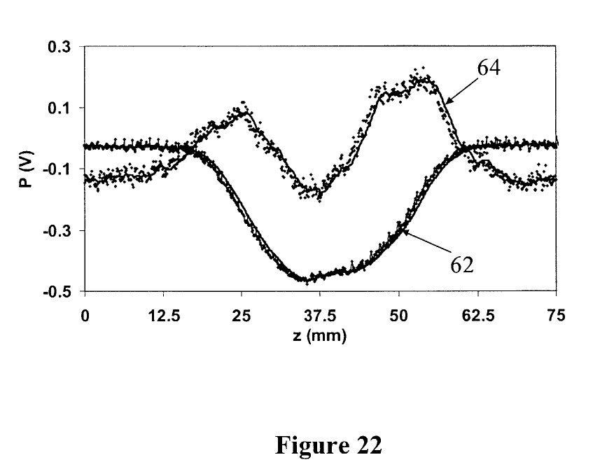

FIG. 22 shows the results of the analysis, as plots of perturbed power P against perturbation position z. The asymmetric perturbed power is labeled 62, and the symmetric perturbed power is labeled 64. In each case, the points represent measured results, and the solid line is a theoretical fit to the results. The power oscillations caused by the symmetric perturbation were very weak, giving a relatively noisy signal. However, the results for the symmetric perturbation follow the coupling profile of the theoretical structure, with two coupling regions and a region with low coupling strength between them. Distortion of the measured profile may be caused (i) by averaging of the ideal profile by the size of the burner flame, (ii) by noise while analyzing the coupler, and (iii) by any tilt in the CO₂ laser position along the coupler. The asymmetric perturbation was achieved by rotating the fiber coupler about its longitudinal axis by 90° from its position during symmetric perturbation. The asymmetric results shows an increase of the perturbation until the uncoupled region is reached and then a decrease in the second coupling region. The slight tilt in the perturbation is probably due to a change in ko along the coupler. However, when compared to the theoretical fits, the experimental data are in very good agreement.

Conclusions

The experimental results fully verify the numerical simulations and theoretical derivations presented herein, and indicate the usefulness of the claimed methods. In particular, the methods provide a non-destructive technique for analyzing a wide variety of waveguide couplers. The methods permit, among other things:

Mapping of the coupling profile by inducement of a symmetric perturbation and measurement of the transmitted power. This gives information about the uniformity of coupler waist and of the shape of any taper regions;

Mapping of the power evolution along an individual waveguide by inducement of an asymmetric perturbation and measurement of the phase of the transmitted light;

Determination of features of the power distribution by inducement of an asymmetric perturbation and measurement of the transmitted power;

Location of the 50-50% and 0-100% points in a single or multiple full-cycle coupler, with the application of corrections if the coupler has been analyzed with a detuning phase displacement;

Location of the 50-50% point in a half-cycle coupler, which is independent of the probe wavelength used and hence does not require a tunable probe source or the application of any corrections;

Full analysis by combining asymmetric and symmetric perturbations; and

Full analysis by inducing asymmetric perturbations at different powers of incident perturbing radiation

Although experimental results have been presented for only some types of coupler, the numerical simulations demonstrate that the method can be applied more widely. Indeed, the method is suitable for the analysis of couplers of many geometries and types, including fiber couplers and planar waveguide couplers, uniform and non-uniform couplers, full and half-cycle couplers, multicycle couplers, and also couplers comprising more than two individual waveguides.

REFERENCES

Y. Bourbin, A. Enard, M. Papuchon, K. Thyagarajan. “The local absorption technique: A straightforward characterization method for many optical devices”, Journal of Lightwave Technology, LT-5(5), pp684-687, 1987.

H. Gnewuch, J. E. Roman, M. Hempstead, J. S. Wilkinson, R. Ulrich, “Beat length measurement in directional couplers by thermo-optic modulation”, Optics Letters, 21(15), pp. 1189-1191, 1996.

What is claimed is:

1. A method of analyzing a waveguide coupler having a coupling region with axial length and comprising first and second waveguides extending side-by-side, the method comprising:
introducing probe light into the coupler;
providing a source of perturbing radiation having a direction of incidence onto the coupling region;
generating a temperature gradient across the coupling region by arranging the first and second waveguides in line with the direction of incidence of the perturbing radiation, thereby to perturb the coupling region asymmetrically and non-destructively;
monitoring the probe light transmitted by the coupler; and
repeating the generating and monitoring steps for a sequence of axial length portions of the coupling region.

2. A method according to claim 1, wherein the transmitted probe light has a power which is monitored during the monitoring step.

3. A method according to claim 2, wherein the monitoring of the power of the transmitted probe light includes noting at which axial length portion or portions the power has a maximum and/or a minimum value.

4. A method according to claim 3, and further comprising applying a correction to an axial position of the noted axial length portion or portions in the event that the coupler is a single- or multiple-cycle full-cycle coupler and the analysis is carried out under conditions in which the coupler is detuned from ideal operation.

5. A method according to claim 4, in which the detuning arises from distortion of the axial length of the coupling region.

6. A method according to claim 4, in which the detuning arises from the probe light having a wavelength which differs from a wavelength at which ideal operation of the coupler is defined.

7. A method according to claim 1, wherein the transmitted probe light has a phase which is monitored during the monitoring step.

8. A method according to claim 1, wherein the perturbing radiation comprises electromagnetic radiation.

9. A method according to claim 1, wherein the perturbing radiation comprises heat radiation.

10. A method of analyzing a waveguide coupler having a coupling region with axial length and comprising first and second waveguides extending side-by-side, the method comprising:
introducing probe light into the coupler;
providing a source of perturbing radiation having a direction of incidence onto the coupling region;
generating a temperature gradient across the coupling region by arranging the first and second waveguides crossways to the direction of incidence of the perturbing radiation and exposing the first and second waveguides together to the perturbing radiation, thereby to perturb the coupling region symmetrically and non-destructively;
monitoring the probe light transmitted by the coupler; and
repeating the generating and monitoring steps for a sequence of axial length portions of the coupling region.

11. A method according to claim 10, wherein the transmitted probe light has a power which is monitored during the monitoring step.

12. A method according to claim 10, wherein the perturbing radiation comprises electromagnetic radiation.

13. A method according to claim 12, wherein the source is a laser.

14. A method according to claim 12, wherein the electromagnetic radiation has a wavelength selected to have an absorption length in the coupling region of between 0.1 and 7 times a distance equal to half of the coupling region width.

15. A method according to claim 14, wherein the waveguide coupler is an optical fiber waveguide coupler with a coupling region having a radius which comprises the distance equal to half of the coupling region width.

16. A method according to claim 13, wherein the coupling region is made from a material comprising silica and the source is a carbon dioxide laser.

17. A method according to claim 10, wherein the perturbing radiation comprises heat radiation.

18. A method according to claim 17, wherein the source is a resistively heated element.

19. A method of analyzing a waveguide coupler having a coupling region with axial length and comprising first and second waveguides extending side-by-side, the method comprising:
introducing probe light into the coupler;
providing a source of perturbing radiation;
selecting a first direction from which to present the coupling region to the perturbing radiation;
presenting the coupling region to the perturbing radiation;
monitoring the probe light transmitted by the coupler;
repeating the presenting and monitoring steps for a sequence of axial length portions of the coupling region;
selecting a second direction from which to present the coupling region to the perturbing radiation; and
repeating the presenting and monitoring steps for a sequence of axial length portions of the coupling region;
wherein presenting the coupling region from one of the first direction and the second direction exposes the first waveguide prior to the second waveguide so as to generate a temperature gradient across the coupling region, thereby to perturb the coupling region asymmetrically and non-destructively, and presenting the coupling region from the other of the first direction and the second direction exposes the first and second waveguides together so as to generate a temperature gradient across the coupling region, thereby to perturb the coupling region symmetrically and non-destructively.

20. A method of analyzing a waveguide coupler having a coupling region with axial length and comprising first and second waveguides extending side-by-side, the method comprising:
introducing probe light into the coupler;
providing a source of perturbing radiation;
setting the perturbing radiation to a first power;
presenting the coupling region to the perturbing radiation from a direction that exposes the first waveguide prior to the second waveguide so as to generate a temperature gradient across the coupling region, thereby to perturb the coupling region asymmetrically and non-destructively;
monitoring the probe light transmitted by the coupler;
repeating the presenting and monitoring steps for a sequence of axial length portions of the coupling region;
setting the perturbing radiation to a second power different from the first power; and
repeating the presenting and monitoring steps for a sequence of axial length portions of the coupling region.

21. Apparatus for analyzing a waveguide coupler, comprising:
a source of probe light operable to emit probe light for introducing into a waveguide coupler;
a mount for holding a waveguide coupler;
a source of perturbing radiation operable to direct light radiation having a component of at least 2 μm in wavelength onto a waveguide coupler held in the mount with a direction of incidence;
a scanning arrangement operable to present a sequence of axial length portions of the coupling region of a waveguide coupler held in the mount to the perturbing radiation; and
a detector operable to monitor probe light transmitted by a waveguide coupler held in the mount.

22. Apparatus according to claim 21, wherein the mount and/or the light source allows a waveguide coupler held in the mount to be rotated relative to the direction of incidence of the perturbing radiation.

23. Apparatus according to claim 21, wherein the source of perturbing radiation has a component of at least 3, 4, 5, 6, 7, 8, 9 or 10 μm in wavelength.
